(19) United States
(12) Patent Application Publication
(10) Pub. No.: US 2024/0166514 A1
(43) Pub. Date: May 23, 2024

(54) RAPID SYNTHESIS OF A SULFIDE-BASED SOLID ELECTROLYTE

(71) Applicant: Solid Power Operating, Inc., Louisville, CO (US)

(72) Inventors: Brian E. FRANCISCO, Arvada, CO (US); Samuel Oberwetter, Lafayette, CO (US)

(21) Appl. No.: 18/516,915

(22) Filed: Nov. 21, 2023

Related U.S. Application Data
(60) Provisional application No. 63/426,969, filed on Nov. 21, 2022.

(51) Int. Cl. C01B 17/22

(52) U.S. Cl. CPC C01B 17/22; C01P 2002/72; C01P 2004/51; C01P 2006/40

(57) ABSTRACT

Provided herein are methods for synthesizing sulfide-based solid electrolytes, including those with an Argyrodite phase. The methods generally comprise mixing electrolyte precursors in a blend of solvents comprising a catalytic solvent and a spectator solvent.

### CROSS-REFERENCE TO RELATED APPLICATION

This application is related to and claims priority under 35 U.S.C. § 119(e) from U.S. Patent Application No. 63/426,969 filed Nov. 21, 2022, titled “Rapid Synthesis of a Sulfide-Based Solid Electrolyte,” the entire contents of which is incorporated herein by reference for all purposes.

### TECHNICAL FIELD

Various embodiments described herein relate to the field of primary and secondary electrochemical cells, solid electrolytes, and electrolyte materials, and the corresponding methods of making and using the same.

### BACKGROUND

Production of solid electrolytes is a time-consuming process. Solid electrolytes including an Argyrodite phase have recently been identified as having favorable qualities for commercial use. As demand for such electrolytes increases, there is an associated increase in demand for efficient production of solid electrolytes, including those with an Argyrodite phase.

### SUMMARY

Provided herein are methods for producing a sulfide-based solid electrolyte. The methods generally comprise mixing an alkali or alkaline earth metal sulfide, a secondary sulfide, and optionally an alkali halide or pseudohalide to produce a sulfide-based solid electrolyte, wherein the mixing occurs in a blend of solvents comprising a catalytic solvent and a spectator solvent and crystallizing the sulfide-based solid electrolyte. In some embodiments, the method further comprises heating the sulfide-based solid electrolyte. In some aspects, the sulfide-based solid electrolyte is heated to a temperature of about 350° C. to about 550° C. In some embodiments, the method further comprises milling the mixture. In still further embodiments, the method further comprises drying the sulfide-based solid electrolyte under vacuum or atmospheric pressure.

In some embodiments, the sulfide-based solid electrolyte comprises Li₃PS₄ (LPS). In some examples, the Li₃PS₄ is crystalline. In other examples, the Li₃PS₄ is amorphous. In some embodiments, the sulfide-based solid electrolyte comprises at least 60% crystalline phase. In some aspects, the crystalline phase is metastable. In some embodiments, the sulfide-based solid electrolyte comprises an Argyrodite phase. In some embodiments, the sulfide-based solid electrolyte is at least 90% phase pure (wt %).

In some embodiments, the sulfide-based solid electrolyte comprises fewer impurities as compared to a sulfide-based solid electrolyte prepared with a non-coordinating non-reactive solvent. In some aspects, the sulfide-based solid electrolyte has a at least a 25% greater ionic conductivity as compared to a sulfide-based solid electrolyte prepared with a non-coordinating non-reactive solvent.

In some embodiments, the method further comprises mixing the alkali halide. In some aspects, the alkali halide comprises LiX, where X is one or more of F, Cl, Br, and I. In some examples, the sulfide-based solid electrolyte comprises less than 1% LiCl.

In some embodiments, the method further comprises producing a thiophosphate intermediate. In some aspects, the thiophosphate intermediate comprises P₂S₆⁴⁻ and/or PS(₄₋ₓ)Oₓ, wherein x is between 0 and 4. In some additional aspects, the thiophosphate intermediate comprises PS₄³⁻. In still further aspects, the thiophosphate intermediate comprises P₂S₇⁴⁻. The term “intermediate” is used to highlight the fact that, in certain syntheses, this particular phase is not desired, particularly in the end product, but it may be observed to form during a heat treatment of a solid electrolyte material or mixture of precursors. In general terms the composition and structure of an intermediate phase may provide information about the effectiveness of methods used to combine precursor materials to form a desired product. For example, if a desired phase contains 4 elements, but an intermediate phase is observed to contain only 3 elements, then the subsequent addition of the 4th element to form the final product may be difficult and require one or more of further mixing, additional heat treatment time, or increased heat treatment temperature. However, if a desired phase contains 4 elements, and an intermediate phase is observed to contain the same 4 elements, then the intermediate phase indicates that the methods used to combine precursor materials are effective and may reduce the subsequent heat treatment time and/or temperature required to produce the desired product and may result in a product with higher purity.

In some embodiments, the alkali metal sulfide comprises A₂S where A is one or more of Li and Na. In some examples, the sulfide-based solid electrolyte comprises less than 1% Li₂S.

In some embodiments, the secondary sulfide comprises one or more of P₂S₅, SiS₂, Sb₂S₃, GeS₂, and SnS₂.

In some embodiments, the catalytic solvent is no more than 0.1 to 6 wt % of the blend of solvents. In some aspects, the catalytic solvent is no more than 0.3 to 4.5 wt % of the blend of solvents. In some additional aspects, the catalytic solvent is no more than 0.5 to 1.5 wt % of the blend of solvents. In still further aspects, the catalytic solvent is no more than 0.6 to 0.9 wt % of the blend of solvents.

In some embodiments, the catalytic solvent comprises one or more nitrile solvents. In some aspects, the one or more nitrile solvents may be selected from the group consisting of acetonitrile, propionitrile, butyronitrile, isobutyronitrile, benzonitrile, and combinations thereof.

In some embodiments, the spectator solvent is 94.0 to 99.9 wt % of the blend of solvents. In some aspects, the spectator solvent is 98.5 to 99.9 wt % of the blend of solvents.

In some embodiments, the spectator solvent comprises a hydrocarbon-based solvent. In some aspects, the spectator solvent comprises an alkane, a blend of alkanes, xylene, toluene, benzene, decalin, 1,2,3,4-tetrahydronaphthalene, or combinations thereof.

It may be understood that there may be multiple ways to consider the quantities of the catalytic and spectator solvents. In many examples presented herein solvent quantities are discussed in terms of weight % (wt %) of a catalytic solvent relative to the combined mass of catalytic and spectator solvents. These quantities could also be described by volume %, mol %, or wt % relative to the precursor materials used. In particular, it may be desirable to consider catalytic solvent quantities by a mass ratio or by a mol ratio with one or more precursor materials. Using the Li₃PS₄ (LPS) system made from combination of Li₂S and P₂S₅ as an example, one may consider a ratio of catalytic solvent to Li₂S precursor, a ratio of catalytic solvent to P₂S₅ precursor, or a ratio of catalytic solvent to Li₂S+P₂S₅ precursors. This ratio may be defined by mass, mol, or volume.

In further considering the quantities of catalytic solvent, spectator solvent, and precursor materials, one may consider the quantities of solvents relative to quantities of precursor materials. In such an instance one may define a “solids %” which may be conveniently described as a weight ratio of precursor materials relative to the combined weight of precursor materials and solvents. It may be understood that adjusting solids % may require adjusting the ratio of catalytic solvent to spectator solvent so that appropriate and desirable ratios of each solvent to the precursor materials may be maintained.

In an exemplary embodiment, the sulfide-based solid electrolyte comprises an Argyrodite phase, the alkali metal sulfide comprises Li₂S, the secondary sulfide comprises P₂S₅, and the alkali halide when present comprises Lix, and wherein X═F, Cl, Br, or I.

Further provided herein are methods for producing a sulfide-based solid electrolyte with an Argyrodite phase. The methods generally comprise mixing Li₂S, P₂S₅, and LiX in a blend of solvents comprising a catalytic solvent and a spectator solvent to produce a sulfide-based solid electrolyte with an Argyrodite phase, wherein X═F, Cl, Br, or I; and crystallizing the sulfide-based solid electrolyte, wherein the production of the sulfide-based solid electrolyte occurs at least two times faster in the presence of the catalytic solvent. In preferred embodiments, the production of the sulfide-based solid electrolyte occurs 4 to 25 times faster in the presence of the catalytic solvent.

Further provided herein are methods for producing a sulfide-based solid electrolyte with an Argyrodite phase. The methods generally comprise mixing sulfide solid-state electrolyte precursors comprising Li₂S, P₂S₅, and LiX in a blend of solvents comprising a catalytic solvent and a spectator solvent to produce a sulfide-based solid electrolyte with an Argyrodite phase, wherein X═F, Cl, Br, or I; and crystallizing the sulfide-based solid electrolyte, wherein the mixing time of the sulfide-based solid electrolyte precursors occurs at least two times faster in the presence of the catalytic solvent. In preferred embodiments, the mixing time of the sulfide-based solid electrolyte precursors occurs 4 to 25 times faster in the presence of the catalytic solvent.

Further provided herein are methods for producing a sulfide-based solid electrolyte with an Argyrodite phase. The methods generally comprise mixing Li₂S, P₂S₅, and LiX in a blend of solvents comprising a catalytic solvent and a spectator solvent to produce a sulfide-based solid electrolyte with an Argyrodite phase, wherein X═F, Cl, Br, or I; and crystallizing the sulfide-based solid electrolyte, wherein the production of the sulfide-based solid electrolyte occurs in less than 20 hours. In some aspects, the production of the sulfide-based solid electrolyte occurs in less than 15 hours. In further aspects, the production of the sulfide-based solid electrolyte occurs in less than 10 hours. In still further aspects, the production of the sulfide-based solid electrolyte occurs in less than 8 hours. In still further aspects, the production of the sulfide-based solid electrolyte occurs in less than 6 hours. In still further aspects, the production of the sulfide-based solid electrolyte occurs in less than 5 hours.

In some embodiments, the sulfide-based solid electrolyte comprises an Argyrodite phase. In some additional embodiments, the sulfide-based solid electrolyte comprises at least 85% crystalline phase. In some aspects, the crystalline phase is metastable.

In some embodiments, the sulfide-based solid electrolyte is at least 90% pure (wt %). In some additional embodiments, the sulfide-based solid electrolyte comprises less than 1% LiCl. In further embodiments, the sulfide-based solid electrolyte comprises less than 1% Li₂S.

Further provided herein is a method for producing a sulfide-based solid electrolyte with an Argyrodite phase. The method generally comprises mixing sulfide-based solid electrolyte precursors comprising Li₂S, P₂S₅, and LiX in a blend of solvents comprising a catalytic solvent and a spectator solvent to produce a sulfide-based solid electrolyte, wherein X═F, Cl, Br, or I; and crystallizing the sulfide-based solid electrolyte, wherein the required mixing time of the sulfide-based solid electrolyte precursors is half (50%) or less in the presence of the catalytic solvent compared to using a spectator solvent only.

Further provided herein are methods for producing a sulfide-based solid electrolyte with an Argyrodite phase. The methods generally comprise mixing Li₂S, P₂S₅, and LiX in a blend of solvents comprising a catalytic solvent and a spectator solvent to produce a sulfide-based solid electrolyte with an Argyrodite phase, wherein X═F, Cl, Br, or I; and crystallizing the sulfide-based solid electrolyte.

Further provided herein are compositions comprising a Li₃PS₄ and a thiophosphate comprising one or more of PS₄ and P₂S₇ and P₂S₆ and an Argyrodite phase, wherein the composition comprises from 0.01 to 0.90 wt % of a nitrile selected from the group consisting of acetonitrile, propionitrile, butyronitrile, isobutyronitrile, benzonitrile, and combinations thereof.

Further provided herein are methods for producing a sulfide-based solid electrolyte with an Argyrodite phase. The methods generally comprise mixing Li₂S, P₂S₅, and LiX in a blend of solvents comprising a catalytic solvent and a spectator solvent to produce a sulfide-based solid electrolyte with an Argyrodite phase, wherein X═F, Cl, Br, or I, and the ratio of catalytic solvent to spectator solvent is from 1:15 to 1:1000 by weight; and crystallizing the sulfide-based solid electrolyte.

Further provided herein are methods for producing a sulfide-based solid electrolyte with an Argyrodite phase. The methods generally comprise mixing Li₂S, P₂S₅, and LiX to produce a sulfide-based solid electrolyte with an Argyrodite phase, wherein the mixing occurs in a blend of solvents comprising a catalytic solvent and a spectator solvent, and X═F, Cl, Br, or I; and, crystallizing the sulfide-based solid electrolyte with less than 0.5 wt % of catalytic solvent incorporated into the sulfide-based solid electrolyte.

Further provided herein are compositions comprising a sulfide-based solid electrolyte with an Argyrodite phase comprising a nitrile selected from the group consisting of acetonitrile, propionitrile, butyronitrile, isobutyronitrile, benzonitrile, and combinations thereof, in amount less than 0.1 wt %. In some embodiments, less than 0.05 wt % of the nitrile is incorporated into the sulfide-based solid electrolyte. In some additional embodiments, less than 0.01 wt % of the nitrile is incorporated into the sulfide-based solid electrolyte. In still further embodiments, less than 0.001 wt % of the nitrile is incorporated into the sulfide-based solid electrolyte.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure may be understood by reference to the following detailed description taken in conjunction with the drawings briefly described below. It is noted that, for purposes of illustrative clarity, certain elements in the drawings may not be drawn to scale.

FIG. 1 shows x-ray diffraction (XRD) spectra of solid electrolyte materials synthesized using various methods of the present disclosure.

FIG. 2 shows XRD spectra of solid electrolyte materials synthesized using various methods of the present disclosure. The solid electrolyte materials in Batch 2 and Batch 4 may comprise 2 Theta (2θ) values of 15.6, 18.1, 25.7, 30.2, 31.6, and 34.8±0.5, and may correspond to Argyrodite phase values. The solid electrolyte materials in FIG. 1 may comprise at least three, at least four, or at least five 2 Theta (2θ) values selected from the group consisting of 15.6, 18.1, 25.7, 30.2, 31.6, and 34.8±0.5, and may correspond to Argyrodite phase values

FIG. 3 shows XRD spectra of solid electrolyte materials synthesized using various methods of the present disclosure.

FIG. 4 shows XRD spectra of solid electrolyte materials synthesized using various methods of the present disclosure.

FIG. 5 shows XRD spectra of solid electrolyte materials synthesized using non-coordinating and non-reactive solvents.

FIG. 6 shows the ionic conductivity of solid electrolyte materials synthesized using non-coordinating and non-reactive solvents.

FIG. 7 shows XRD spectra of solid electrolyte materials synthesized using coordinating and reactive solvents including an ester.

FIG. 8 shows the ionic conductivity of solid electrolyte materials synthesized using coordinating and reactive solvents including an ester.

FIG. 9 shows XRD spectra of solid electrolyte materials synthesized using coordinating and reactive solvents including a nitrile.

FIG. 10 shows the ionic conductivity of solid electrolyte materials synthesized using coordinating and reactive solvents comprising a nitrile.

FIG. 11 shows an overlay of the ionic conductivity of solid electrolyte materials synthesized using non-coordinating and non-reactive solvents, coordinating and reactive solvents including an ester, and coordinating and reactive solvents including a nitrile, and heated for 3 hours.

FIG. 12 shows an overlay of the ionic conductivity of solid electrolyte materials synthesized using non-coordinating and non-reactive solvents, coordinating and reactive solvents including an ester, and coordinating and reactive solvents including a nitrile, and heated for 12 hours.

FIG. 13 shows the particle size distribution of solid electrolyte materials synthesized using coordinating and reactive solvents including an ester and coordinating and reactive solvents including a nitrile after milling for 3 hours.

FIG. 14 shows XRD spectra of solid electrolyte materials synthesized using coordinating and reactive solvents including a nitrile and heating during milling.

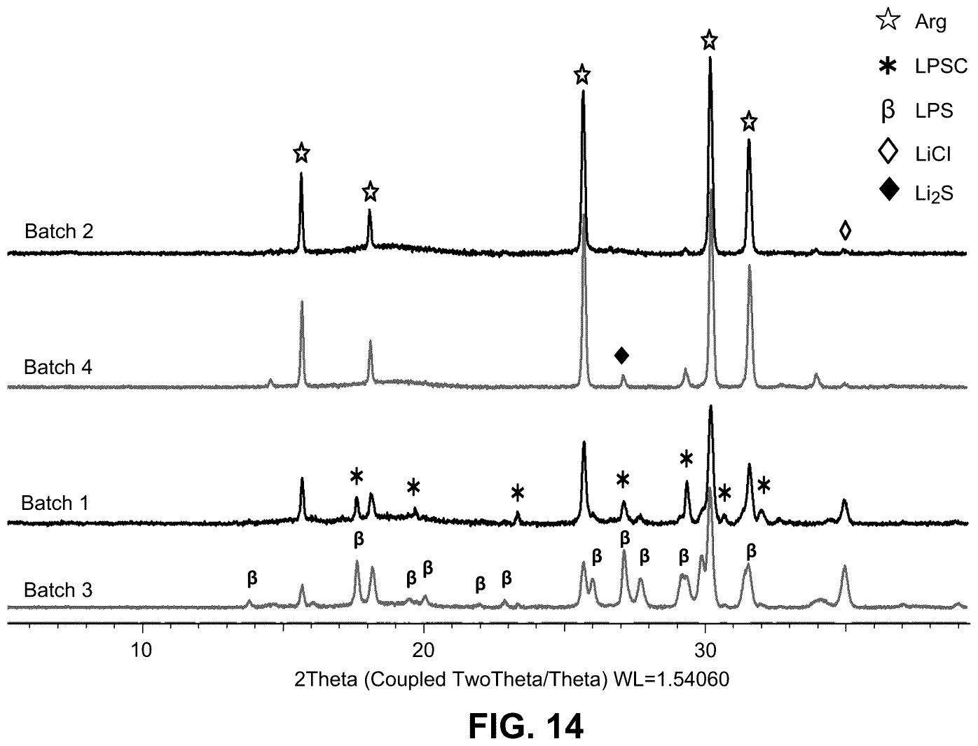

FIG. 15 shows photographs of materials synthesized using methods of the present disclosure.

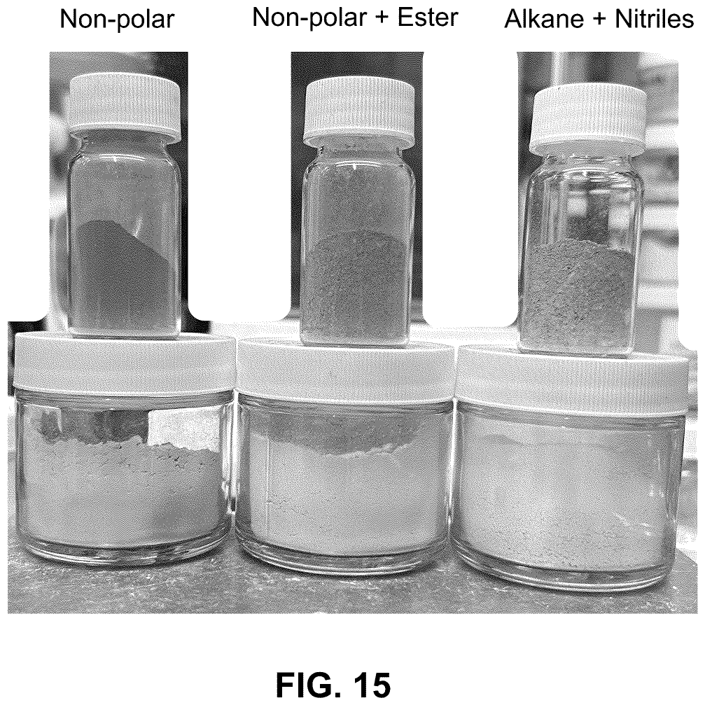

FIG. 16 shows a graph of the molar ratio of aliphatic (IBN) to aromatic solvents (BZN) vs. the conductivity in some embodiments of the present disclosure.

### DETAlLED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

Provided herein are methods for producing a sulfide-based solid electrolyte. Also provided herein are methods for producing a sulfide-based solid electrolyte with an Argyrodite phase. The method(s) comprise mixing (1) an alkali metal sulfide and/or an alkaline earth metal sulfide, (2) a secondary sulfide, and (3) a halide or pseudohalide to produce a sulfide-based solid electrolyte or intimate mixture of sulfide-based solid electrolyte precursor materials, and then applying energy input to complete the reaction between precursor materials and/or crystallize the sulfide-based solid electrolyte. Also provided herein is a method for producing a sulfide-based solid electrolyte comprising: mixing an alkali or alkaline earth metal sulfide, a secondary sulfide, and optionally an alkali halide or pseudohalide to produce a sulfide-based solid electrolyte, wherein the mixing occurs in a blend of solvents comprising a catalytic solvent and a spectator solvent, and crystallizing the sulfide-based solid electrolyte. The produced sulfide-based solid electrolyte may be in an Argyrodite phase.

Herein, the term ‘catalytic’ may be used to describe a material such as a solvent that coordinates with or bonds to the surfaces of the precursor materials or combination of precursor materials in a manner that alters the size, morphology, and/or surface area of the solids. For example, nitrile solvents may be added in varying amount to the reaction solvents to improve the property of the resulting electrolyte.

The mixing step may be accomplished using a blend of solvents comprising a catalytic solvent and a spectator solvent. Generally, the purpose of the catalytic solvent may comprise coordinating with reactants, breaking down reactants, and/or changing the morphology of reactants such that subsequent reactions between reactants proceed more quickly and more completely with less energy input. Additionally, the action of the catalytic solvent may comprise the mediation of combinations of or reaction between reactants, the facilitation of combinations of or reactions between reactants, or the expediting of combinations of or reactions between reactants. An example of such an action may be the combination of P₂S₅ and Li₂S to form Li₃PS₄. Furthermore, the catalytic solvent may coordinate with or bond to the surfaces of the precursor materials or combination of precursor materials in a manner that alters the size, morphology, and/or surface area of the solids. The catalytic solvent may also be described as a coordinating solvent and/or a reactive solvent. According to the descriptions here the term ‘catalytic’ may be used differently than in other fields, as some embodiments herein involve the direct participation of the catalytic solvent in chemical reactions which may cause chemical changes to the catalytic solvent.

It may be understood that P₂S₅ and P₄S₁₀ may be referred to interchangeably and all ratios based on such material should be adjusted according the the appropriate calculations.

The purpose of the spectator solvent may comprise suspending, dispersing, distributing, and/or interacting with the reactants in a way that improves synthesis outcomes (e.g., yields) without directly facilitating, participating in, or causing a reaction between the reactants. The spectator solvent may also be described as an inert solvent, a non-reactive solvent, a non-coordinating solvent, a processing aid, and/or a fluidizing solvent.

The methods described herein are capable of producing sulfide-based solid electrolytes (e.g., with an Argyrodite phase) more efficiently than the processes of the prior art. Improved production efficiency may be realized through lowering the mixing or milling energy input to precursor materials, reducing the temperature required to remove any solvents, reducing the time required to remove any solvents, lowering the reaction or crystallization temperature, and/or lowering the reaction or crystallization time. Additionally, the sulfide-based solid electrolyte may comprise Li₃PS₄, Li₇P₃S₁₁, Li₄P₂S₆, Li₇PS₆, Li₇₋ₓPS₆₋ₓHₓ, and/or Li₁₅₊ₓP₄S₁₆₊ₓH₃₋ₓ(where H=halogen or pseudohalogen). The Li₃PS₄, Li₇P₃S₁₁, Li₄P₂S₆. Li₇PS₆, Li₇₋ₓPS₆₋ₓHₓ, and/or Li₁₅₊ₓP₄S₁₆₊ₓH₃₋ₓ (where H=halogen or pseudohalogen) may be crystalline, amorphous, or a composite of crystalline or nanocrystalline domains and amorphous domains. Materials considered to be amorphous generally do not exhibit peaks in x-ray diffraction measurements prior to heat treatments.

The alkali metal sulfide and/or alkaline earth metal sulfide may comprise any alkali metal sulfide or alkaline earth metal sulfide known in the art. For example, the alkali metal sulfide and/or alkaline earth metal sulfide may comprise Li₂S, Na₂S, K₂S, MgS, CaS, BaS, and combinations thereof. In preferred embodiments, the alkali metal sulfide and/or alkaline metal sulfide comprises Li₂S and/or Na₂S.

The secondary sulfide may comprise any sulfide known in the art. For example, the secondary sulfide may comprise P₂S₅, AS₂S₅, AS₂S₃, Sb₂S₅, Sb₂S₃, Al₂S₃, SiS₂, GeS₂, SnS₂, or PbS₂ or combinations thereof. The secondary sulfide may also or alternatively comprise a transition metal sulfide, such as CoS₂, Co₃S₄, CrS, Cr₂S₃, Cr₃S₄, CuS, CuS₂, Cu₂S, FeS, FeS₂, Fe₃S₄, MnS, MnS₂, MoS₂, NiS, NiS₂, Ni₃S₂, ScS, SC₂S₃, SnS₂, TiS, TiS₂, Ti₂S₃, VS, VS₂, V₂S₃, VS₄, Y₂S₃, ZnS, ZrS₂, WS₂, or other transition metal sulfides known in the art and combinations thereof.

The halide may comprise an alkali metal halide, a secondary halide, a semi-metal halide, a pseudohalide, and combinations thereof. For example, the halide may comprise LiF, LiCl, LiBr, LiI, BCl₃, BBr₃, Bl₃, AlF₃, AlBr₃, AlI₃, AlCl₃, SiF₄, SiCl₄, SiCl₃, Si₂Cl₆, SiBr₄, SiBrCl₃, SiBr₂Cl₂, SiI₄, PF₃, PF₅, PCl₃, PCl₅, POCl₃, PBr₃, POBr₃, PI₃, P₂Cl₄, P₂I₄, SF₂, SF₄, SF₆, S₂F₁₀, SCl₂, S₂Cl₂, S₂Br₂, GeF₄, GeCl₄, GeBr₄, Gel₄, GeF₂, GeCl₂, GeBr₂, GeI₂, AsF₃, AsCl₃, AsBr₃, AsI₃, AsF₅, SeF₄, SeF₆, SeCl₂, SeCl₄, Se₂Br₂, SeBr₄, SnF₄, SnCl₄, SnBr₄, SnI₄, SnF₂, SnCl₂, SnBr₂, SnI₂, SbF₃, SbCl₃, SbBr₃, SbI₃, SbF₅, SbCl₅, PbF₄, PbCl₄, PbF₂, PbCl₂, PbBr₂, PbI₂, BiF₃, BiCl₃, BiBr₃, Bil₃, TeF₄, Te₂F₁₀, TeF₆, TeCl₂, TeCl₄, TeBr₂, TeBr₄, TeI₄, NaI, NaF, NaCl, NaBr, and combinations thereof. Additionally, the halide may comprise the pseudohalides LiBH₄, LiBF₄, LINH₂, LINO₃, LISCN, LIOCN, and combinations thereof. In particular embodiments, the halide may comprise one or more of an alkali metal halide having the formula LiX, where Li is an alkali metal and X═F, Cl, Br, or I.

The catalytic solvent may comprise one or more of ketone, ether, ester, aldehyde, amine, nitro, and/or nitrile solvents. In particular, the catalytic solvent may comprise one or more nitrile solvents and/or aromatic solvents comprising nitrogen. Without wishing to be bound by theory, the catalytic solvent may steer the reaction toward the production of thermodynamically stable, high temperature phases such as Argyrodite and Li₄PS₄I. Sulfide-based solid electrolytes prepared with one or more nitrile solvents may contain fewer impurities and may have a higher ionic conductivity as compared to sulfide-based solid electrolytes prepared in the presence of only a non-coordinating non-reactive solvent.

Surprisingly, it was discovered that the sulfide-based solid electrolyte may have an increased ionic conductivity even if the mixing and the alloying is performed before introducing the one or more nitrile solvents. In some embodiments, the one or more nitrile solvents may include an alkyl solvent substituted with one or more nitrile groups. The alkyl solvent substituted with one or more nitrile groups may be acyclic. The alkyl solvent substituted with one or more nitrile groups may be linear or branched. The alkyl solvent substituted with one or more nitrile groups may have a chain length from 1 to 30 carbons, such as from 1 to 20 carbons, from 1 to 15 carbons, 1 to 10 carbons, 1 to 8 carbons, or 1 to 6 carbons. In some embodiments, the alkyl solvent substituted with one or more nitrile groups may have a chain length of 2 or more carbons, 3 or more carbons, 4 or more carbons, 5 or more carbons, 6 or more carbons, 7 or more carbons, 8 or more carbons, and so on. In some examples, the alkyl solvent substituted with one or more nitrile groups may include acetonitrile, propionitrile, butyronitrile, isobutyronitrile, benzonitrile, decanonitrile, pivalonitrile, valeronitrile, or a combination thereof.

In some embodiments, the one or more nitrile solvents may include an aryl solvent substituted with one or more nitrile groups. The aryl solvent substituted with one or more nitrile groups may include three or more carbons, four or more carbons, five or more carbons, six or more carbons, seven or more carbons, eight or more carbons, nine or more carbons, ten or more carbons, and so on. In some embodiments, the aryl solvent substituted with one or more nitrile groups may include from 3 to 12 carbons, such as from 3 to 10 carbons, 3 to 8 carbons, 4 to 6 carbons, or from 5 to 7 carbons. In some examples, the aryl solvent substituted with one or more nitrile groups may include benzonitrile.

In some embodiments, the one or more nitrile solvents may comprise acetonitrile, propionitrile, butyronitrile, isobutyronitrile, benzonitrile, decanonitrile, pivalonitrile, valeronitrile, or other nitrile solvents known in the art and combinations thereof. In specific embodiments, the one or more nitrile solvents may be selected from the group consisting of acetonitrile, propionitrile, butyronitrile, isobutyronitrile, benzonitrile, and combinations thereof.

In some embodiments, the alkyl solvent substituted with one or more nitrile groups and the aryl solvent substituted with one or more nitrile groups may be present in a volume ratio from about 5:1 to about 10:1. For example, the alkyl solvent substituted with one or more nitrile groups and the aryl solvent substituted with one or more nitrile groups may be present in a volume ratio from about 5:1 to about 6:1, about 5:1 to about 7:1, about 5:1 to about 8:1, about 5:1 to about 9:1, about 5:1 to about 10:1, about 6:1 to about 10:1, about 7:1 to about 10:1, about 8:1 to about 10:1, or about 9:1 to about 10:1.

In some embodiments, the alkyl solvent substituted with one or more nitrile groups and the aryl solvent substituted with one or more nitrile groups may be present in a mass ratio from about 4:1 to about 8:1. For example, the alkyl solvent substituted with one or more nitrile groups and the aryl solvent substituted with one or more nitrile groups may be present in a mass ratio from about 4:1 to about 5:1, about 4:1 to about 6:1, about 4:1 to about 7:1, about 4:1 to about 8:1, about 5:1 to about 8:1, about 6:1 to about 8:1, or about 7:1 to about 8:1.

In some embodiments, the alkyl solvent substituted with one or more nitrile groups and the aryl solvent substituted with one or more nitrile groups may be present in a mol ratio from about 2:1 to about 22:1. For example, the alkyl solvent substituted with one or more nitrile groups and the aryl solvent substituted with one or more nitrile groups may be present in a mol ratio from about 2:1 to about 4:1, about 4:1 to about 8:1, about 8:1 to about 12:1, about 7:1 to about 15:1, about 6:1 to about 18:1, about 6:1 to about 22:1, about 7:1 to about 12:1, about 8:1 to about 12:1, about 9:1 to about 12:1, about 10:1 to about 12:1, or about 11:1 to about 12:1

In some embodiments, the aryl solvent substituted with one or more nitrile groups and the secondary sulfide may be present in a mol ratio from about 0.5:1 to about 1.5:1. For example, the aryl solvent substituted with one or more nitrile groups and the secondary sulfide may be present in a mol ratio from about 0.5:1 to about 0.75:1, about 0.5:1 to about 1:1, about 0.5:1 to about 1.25:1, about 0.5:1 to about 1.5:1, about 0.75:1 to about 1.5:1, about 1:1 to about 1.5:1, or about 1.25:1 to about 1.5:1.

In some embodiments, the aryl solvent substituted with one or more nitrile groups and the secondary sulfide may be present in a mol ratio from about 0.1:1 to about 3:1. For example, the aryl solvent substituted with one or more nitrile groups and the secondary sulfide may be present in a mol ratio from about 0.1:1 to about 0.25:1, about 0.25:1 to about 1:1, about 0.7:1 to about 2.5:1, about 0.5:1 to about 3:1, about 0.75:1 to about 1.5:1, about 1:1 to about 1.5:1, or about 1.25:1 to about 1.5:1.

In particular, the sulfide-based solid electrolytes prepared according to the methods described herein (e.g., with a nitrile solvent) may be at least about 90% pure, at least about 91% pure, at least about 92% pure, at least about 93% pure, at least about 94% pure, at least about 95% pure, at least about 96% pure, at least about 97% pure, at least about 98% pure, at least about 99% pure, at least about 99.3% pure, at least about 99.5% pure, at least about 99.7% pure, or at least about 99.9% pure by weight (wt %) as determined by x-ray diffraction (XRD). The sulfide-based solid electrolytes prepared according to the methods described herein (e.g., with a catalytic solvent) may have less than about 10%, less than about 9%, less than about 8%, less than about 7%, less than about 6%, less than about 5% less than about 4% less than about 3% less than about 2% less than about 1%, less than about 0.5%, less than about 0.3%, or less than about 0.1% by weight (wt %) of LiCl and/or Li₂S, as determined by XRD.

Without being bound by theory, the ionic conductivities of the sulfide-based solid electrolytes prepared according to the methods described herein (e.g., with a catalytic solvent) may be at least about 1.50E-03 S/cm to about 1.75E-03 S/cm, about 1.75E-03 S/cm to about 2.00E-03, about 2.00E-03 S/cm to 2.25E-03, about 2.25E-03 S/cm to about 2.50E-03, about 2.50E-03 S/cm to about 2.75E-03, about 2.75E-03 S/cm to about 3.00E-03 S/cm, about 3.00E-03 S/cm to about 3.25E-03 S/cm, about 3.25E-03 S/cm to about 3.50E-03 S/cm, about 3.50E-03 S/cm to about 3.75E-03 S/cm, about 3.75E-03 S/cm to about 4.00E-03 S/cm, about 4.00E-03 S/cm to about 4.25E-03 S/cm, about 4.25E-03 S/cm to about 4.50E-03 S/cm, about 4.50E-03 S/cm to about 4.75E-03 S/cm, about 4.75E-03 S/cm to about 5.00E-03 S/cm, about 5.00E-03 S/cm to about 5.25E-03 S/cm, or about 5.25E-03 S/cm or greater. The ionic conductivities of the sulfide-based solid electrolytes prepared according to the methods described herein (e.g., with a catalytic solvent) may also be at least about 1.00E-03 S/cm to about 9.00E-03 S/cm, 1.00E-03 S/cm to about 7.00E-03 S/cm, about 1.00E-03 S/cm to about 6.00E-03 S/cm, 1.50E-03 S/cm to about 5.00E-03 S/cm, about 1.50E-03 S/cm to about 4.50E-03 S/cm, about 1.50E-03 S/cm to about 4.00E-03 S/cm, about 1.50E-03 S/cm to about 3.00E-03 S/cm, or about 1.50E-03 S/cm to about 2.50E-03 S/cm. In alternative embodiment, the ionic conductivities of the sulfide-based solid electrolytes prepared according to the methods described herein (e.g., with a catalytic solvent) may also be at least about 1.00E-04 S/cm to about 9.00E-03 S/cm, 1.00E-04 S/cm to about 7.00E-03 S/cm, about 1.00E-04 S/cm to about 6.00E-03 S/cm, 1.50E-04 S/cm to about 5.00E-03 S/cm, about 1.50E-04 S/cm to about 4.50E-03 S/cm, about 1.50E-04 S/cm to about 4.00E-03 S/cm, about 1.50E-04 S/cm to about 3.00E-03 S/cm, or about 1.50E-04 S/cm to about 2.50E-03 S/cm. In yet another embodiment, the ionic conductivities of the sulfide-based solid electrolytes prepared according to the methods described herein (e.g., with a catalytic solvent) may be at least about 1.25 mS/cm to about 6.25 mS/cm, about 1.25 mS/cm to about 5.50 mS/cm, about 1.25 mS/cm to about 4.75 mS/cm, about 1.25 mS/cm to about 3.50 mS/cm, about 1.25 mS/cm to about 2.75 mS/cm, about 1.25 mS/cm to about 1.75 mS/cm, about 2.00 mS/cm to about 2.75 mS/cm, 2.75 mS/cm to about 3.50 mS/cm, about 3.50 mS/cm to about 4.25 mS/cm, about 4.25 mS/cm to about 4.75 mS/cm, about 4.75 mS/cm to about 5.50 mS/cm, or about 5.50 mS/cm to about 6.25 mS/cm.

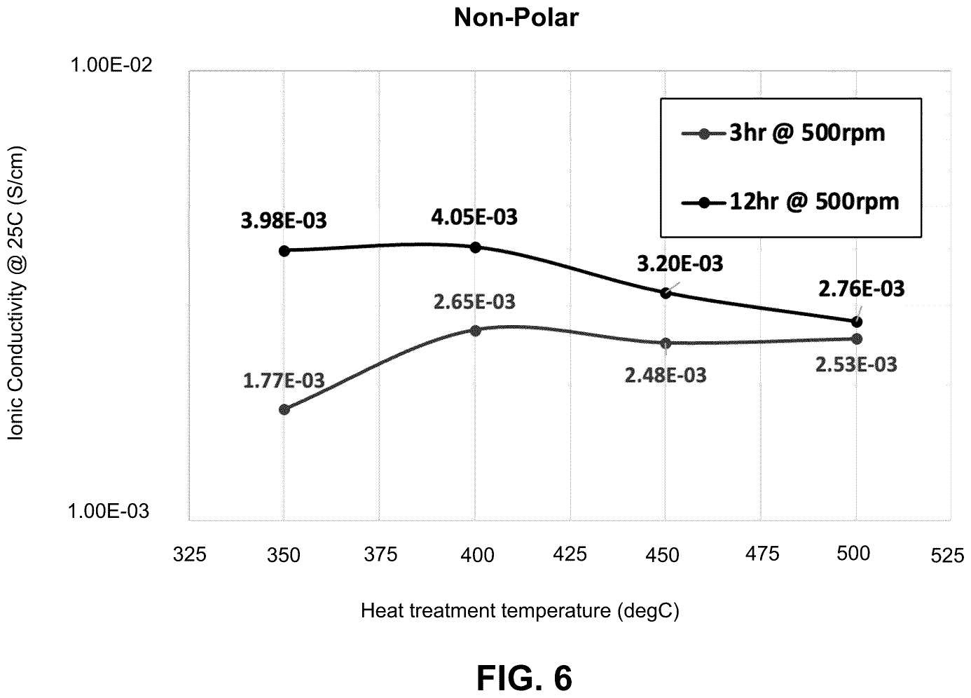

In some embodiments (see, e.g., FIG. 6), the solid electrolyte materials synthesized using the methods of the present disclosure may comprise an ionic conductivity from 1.77E-03 S/cm to 2.65E-03 S/cm, from 2.65E-03 S/cm to 2.48E-03 S/cm, or from 2.48E-03 S/cm to 2.53E-03 S/cm at 3 hr and at 500 rpm, and may show a range of conductivity values after 3-hours of milling and heat treatment(s). The solid electrolyte materials of the present disclosure may also comprise an ionic conductivity from 2.76E-03 S/cm to 4.05E-03 S/cm at 12 hr at 500 rpm, and may show a range of conductivity values after 12-hours of milling and heat treatment(s). In addition, the solid electrolyte materials of the present disclosure may comprise an ionic conductivity from 3.98E-03 S/cm to 4.05E-03 S/cm, from 4.05E-03 S/cm to 3.20E-03 S/cm, or from 3.20E-03 S/cm to 2.76E-03 S/cm at 12 hr and 500 rpm. The heat treatment temperature may be from 350° C. to 400° C., from 400° C. to 450° C., or from 450 to 500° C. (e.g., from 350° C. to 500° ° C. or 350° C. to 450° C.).

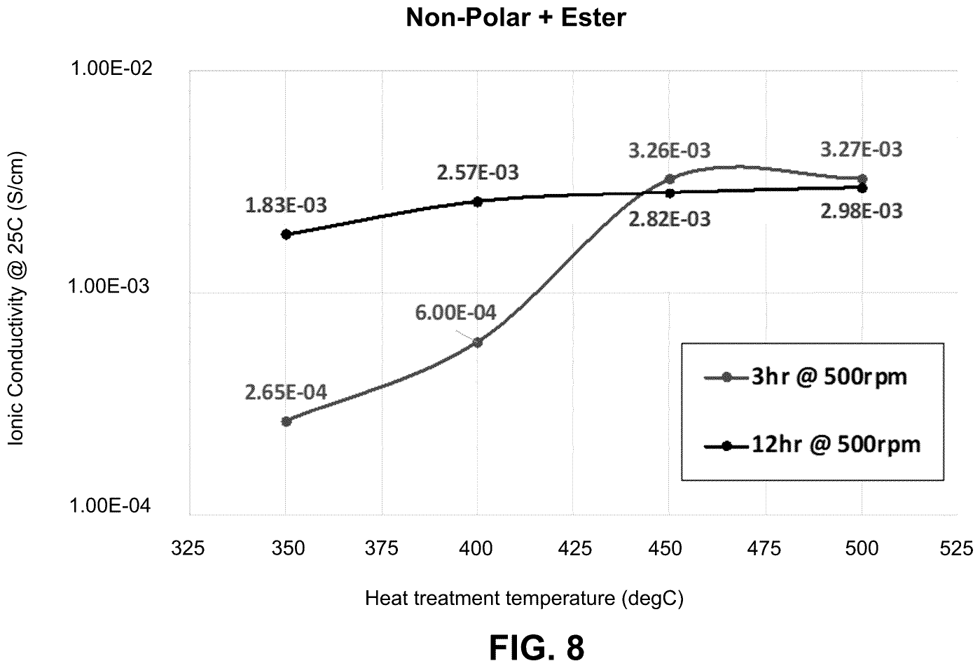

In some embodiments (see, e.g., FIG. 8), the solid electrolyte materials in FIG. 8 may comprise an ionic conductivity from 2.65E-04 S/cm to 6.00E-04 S/cm, from 6.00E-04 S/cm to 3.26E-03 S/cm, or from 3.26E-03 S/cm to 3.27E-03 S/cm at 3 hr and at 500 rpm. The solid electrolyte materials of the present disclosure may also comprise an ionic conductivity from 2.65E-04 S/cm to 3.27E-03 S/cm at 3 hr at 500 rpm. The solid electrolyte materials of the present disclosure may also comprise an ionic conductivity from 1.83E-03 S/cm to 2.98E-03 S/cm at 12 hr at 500 rpm. In addition, the solid electrolyte materials of the present disclosure may comprise an ionic conductivity from 1.83E-03 S/cm to 2.57E-03 S/cm, from 2.57E-03 S/cm to 2.82E-03 S/cm, or from 2.82E-03 S/cm to 2.98E-03 S/cm at 12 hr and 500 rpm. The heat treatment temperature may be from 350° C. to 400° C., from 400° C. to 450° C., or from 450 to 500° C. (e.g., from 350° C. to 500° C.).

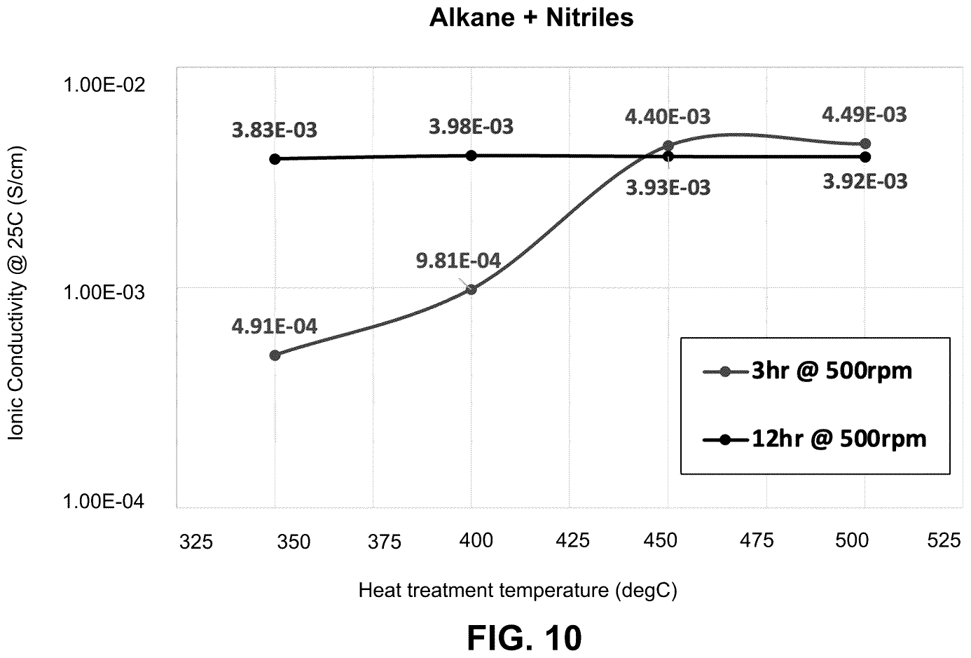

In some embodiments (see, e.g., FIG. 10), the solid electrolyte materials of the present disclosure may comprise an ionic conductivity from 4.91E-04 S/cm to 9.81E-04 S/cm, from 9.81E-04 S/cm to 4.40E-03 S/cm, or from 4.40E-03 S/cm to 4.49E-03 S/cm at 3 hr and at 500 rpm. The solid electrolyte materials of the present disclosure may also comprise an ionic conductivity from 4.91E-04 S/cm to 4.49E-03 S/cm at 3 hr at 500 rpm. The solid electrolyte materials of the present disclosure may also comprise an ionic conductivity from 3.83E-03 S/cm to 3.98E-03 S/cm at 12 hr at 500 rpm. In addition, the solid electrolyte materials of the present disclosure may comprise an ionic conductivity from 3.83E-03 S/cm to 3.98E-03 S/cm, from 3.98E-03 S/cm to 3.93E-03 S/cm, or from 3.93E-03 S/cm to 3.92E-03 S/cm at 12 hr and 500 rpm. The heat treatment temperature may be from 350° C. to 400° C., from 400° C. to 450° C., or from 450 to 500° ° C. (e.g., from 350° C. to 500° C.).

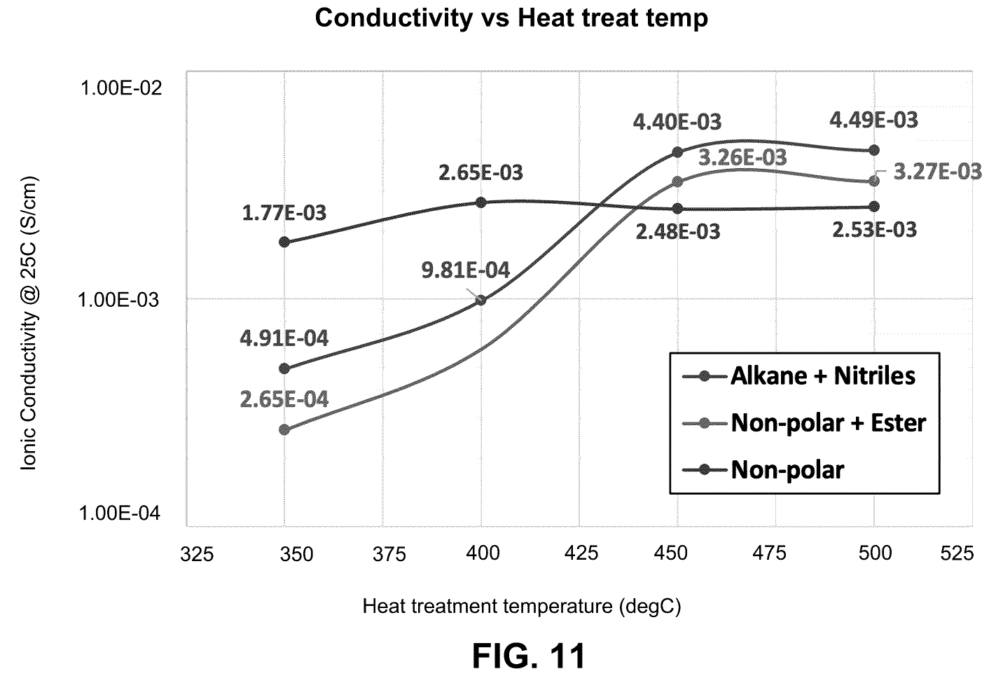

In some embodiments (see, e.g., FIG. 11), the solid electrolyte materials of the present disclosure may comprise an ionic conductivity from 1.77E-03 S/cm to 2.65E-03 S/cm, from 2.65E-03 S/cm to 2.48E-03 S/cm, from 2.48E-03 S/cm to 2.53E-03 S/cm when the material is synthesized using non-coordinating and non-reactive solvents. The solid electrolyte materials of the present disclosure may also comprise an ionic conductivity from 1.77E-03 S/cm to 2.65E-03 S/cm when the material is synthesized using non-coordinating and non-reactive solvents. The solid electrolyte materials of the present disclosure may comprise an ionic conductivity from 4.91E-04 S/cm to 9.81E-04 S/cm, from 9.81E-04 S/cm to 4.40E-03 S/cm, or from 4.40E-03 S/cm to 4.49 E-03 S/cm when the material is synthesized using coordinating and reactive solvents including an ester. The solid electrolyte materials of the present disclosure may also comprise an ionic conductivity from 4.91E-04 S/cm to 4.49E-03 S/cm when the material is synthesized using coordinating and reactive solvents including an ester. The solid electrolyte materials of the present disclosure may also comprise an ionic conductivity from 2.65E-04 S/cm to 3.26E-03 S/cm, or from 3.26E-03 S/cm to 3.27E-03 S/cm when the material is synthesized using coordinating and reactive solvents including a nitrile. The solid electrolyte materials of the present disclosure may also comprise an ionic conductivity from 2.65E-04 S/cm to 3.27E-03 S/cm when the material is synthesized using coordinating and reactive solvents including a nitrile. The heat treatment temperature may be from 350° ° C. to 400° C., from 400° C. to 450° C., or from 450 to 500° C. (e.g., from 350° C. to 500° C.).

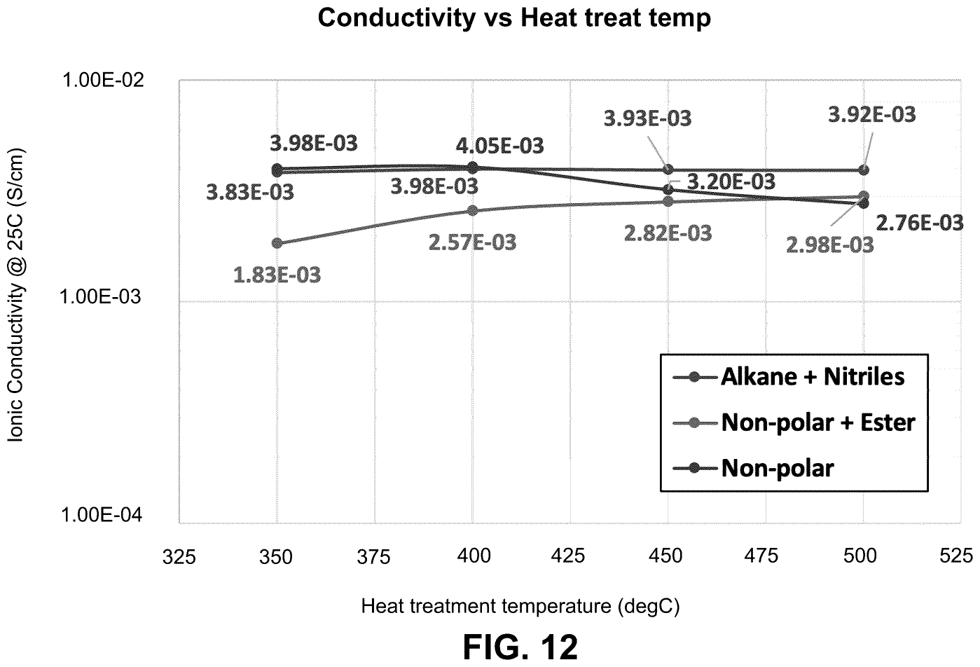

In some embodiments (see, e.g., FIG. 12), the solid electrolyte materials of the present disclosure may comprise an ionic conductivity from 3.98E-03 S/cm to 4.05E-03 S/cm, from 4.05E-03 S/cm to 3.20E-03 S/cm, from 3.20E-03 S/cm to 2.76E-03 S/cm when the material is synthesized using non-coordinating and non-reactive solvents. The solid electrolyte materials of the present disclosure may also comprise an ionic conductivity from 2.76E-03 S/cm to 4.05E-03 S/cm when the material is synthesized using non-coordinating and non-reactive solvents. The solid electrolyte materials of the present disclosure may comprise an ionic conductivity from 1.83E-03 S/cm to 2.57E-03 S/cm, from 2.57E-03 S/cm to 2.82E-03 S/cm, or from 2.82E-03 S/cm to 2.98E-03 S/cm when the material is synthesized using coordinating and reactive solvents including an ester. The solid electrolyte materials of the present disclosure may also comprise an ionic conductivity from 1.83E-04 S/cm to 2.98E-03 S/cm when the material is synthesized using coordinating and reactive solvents including an ester. The solid electrolyte materials of the present disclosure may also comprise an ionic conductivity from 2.65E-04 S/cm to 3.26E-03 S/cm, or from 3.26E-03 S/cm to 3.27E-03 S/cm when the material is synthesized using coordinating and reactive solvents including a nitrile. The solid electrolyte materials of the present disclosure may also comprise an ionic conductivity from 2.65E-04 S/cm to 3.27E-03 S/cm when the material is synthesized using coordinating and reactive solvents including a nitrile. The heat treatment temperature may be from 350° ° C. to 400° C., from 400° ° C. to 450° C., or from 450 to 500° C. (e.g., from 350° C. to 500° C.).

The solid electrolyte materials of the sulfide-based solid electrolytes prepared according to the methods described herein may have a specific surface area after milling from about 0.50 m²/g to about 9.00 m²/g, from about 1.50 m²/g to about 7.00 m²/g, from about 1.50 m²/g to about 5.50 m²/g, from about 1.75 m²/g to about 6.00 m²/g, from about 2.50 m²/g to about 5.00 m²/g, or from about 2.50 m²/g to about 4.5 m²/g. For example, the solid electrolyte materials of the sulfide-based solid electrolytes prepared according to the methods described herein may have a specific surface area after milling from about 1.50 m²/g to about 2.00 m²/g, from about 2.00 m²/g to about 2.50 m²/g, from about 2.50 m²/g to about 3.00 m²/g, from about 3.00 m²/g to about 3.50 m²/g, from about 3.50 m²/g to about 4.00 m²/g, from about 4.00 m²/g to about 4.50 m²/g, from about 4.50 m²/g to about 5.00 m²/g, from about 5.00 m²/g to about 5.50 m²/g, or from about 5.50 m²/g to about 6.00 m²/g.

In some embodiments), the solid electrolyte materials of the present disclosure may have a specific surface area of 1-5 m²/g before heat treatment and about 20-40% lower after heat treatment when the material is synthesized using non-coordinating and non-reactive solvents. The solid electrolyte materials of the present disclosure may have a specific surface area of 10-75 m²/g before heat treatment and about 70-95% lower after heat treatment when the material is synthesized using coordinating and reactive solvents.

The catalytic solvent may be present in the blend of solvents in an amount from about 0.1 to about 6.0 wt %, about 0.1 to about 5.0 wt %, about 0.1 to about 4.5 wt %, about 0.1 to about 4.0 wt %, about 0.1 to about 3.0 wt %, about 0.1 to about 2.0 wt %, about 0.1 to about 1.5 wt %, about 0.2 to about 1.4 wt %, about 0.3 to about 1.3 wt %, about 0.4 to about 1.2 wt %, about 0.5 to about 1.1 wt %, about 0.6 to about 1.0 wt %, or about 0.7 to about 0.9 wt %. For example, the catalytic solvent may be present in the blend of solvents in an amount of about 0.1 wt % to about 0.2 wt %, about 0.1 wt % to about 0.3 wt %, about 0.1 wt % to about 0.4 wt %, about 0.1 wt % to about 0.5 wt %, about 0.1 wt % to about 0.6 wt %, about 0.1 wt % to about 0.7 wt %, about 0.1 wt % to about 0.8 wt %, about 0.1 wt % to about 0.9 wt %, about 0.1 wt % to about 1.0 wt %, about 0.1 wt % to about 1.1 wt %, about 0.1 wt % to about 1.2 wt %, about 0.1 wt % to about 1.3 wt %, about 0.1 wt % to about 1.4 wt %, about 0.1 wt % to about 1.5 wt %, about 0.2 wt % to about 1.5 wt %, about 0.3 wt % to about 1.5 wt %, about 0.4 wt % to about 1.5 wt %, about 0.5 wt % to about 1.5 wt %, about 0.6 wt % to about 1.5 wt %, about 0.7 wt % to about 1.5 wt %, about 0.8 wt % to about 1.5 wt %, about 0.9 wt % to about 1.5 wt %, about 1.0 wt % to about 1.5 wt %, about 1.1 wt % to about 1.5 wt %, about 1.2 wt % to about 1.5 wt %, about 1.3 wt % to about 1.5 wt %, about 1.4 wt % to about 1.5 wt %, about 0.3 wt % to about 1.2 wt %, about 0.5 wt % to about 1.0 wt %, or about 0.6 wt % to about 0.9 wt %.

The spectator solvent may comprise a hydrocarbon solvent. The hydrocarbon solvent may include an alkane, a blend of alkanes, xylene (including para-, meta-, and ortho-xylene), toluene, benzene, heptane, octane, decalin, 1,2,3,4-tetrahydronaphthalene, or combinations thereof. Useful spectator solvents may include alkanes, alkenes, alkynes, and combinations thereof, including but not limited to those with linear, branched, or ring structures and boiling points between 30° C. and 250° C. The alkanes may have 4 to 20 carbons.

The spectator solvent may be present in the blend of solvents in an amount from about 94.0 wt % to about 99.9 wt %, about 95.0 wt % to about 99.9 wt %., about 96.0 wt % to about 99.9 wt %, about 97.0 wt % to about 99.9 wt %, about 98.0 wt % to about 99.9 wt %, or about 98.5 wt % to about 99.9 wt %. For example, the separator solvent may be present in the blend of solvents in an amount from about 98.5 wt % to about 98.6 wt %, about 98.5 wt % to about 98.7 wt %, about 98.5 wt % to about 98.8 wt %, about 98.5 wt % to about 98.9 wt %, about 98.5 wt % to about 99.0 wt %, about 98.5 wt % to about 99.1 wt %, about 98.5 wt % to about 99.2 wt %, about 98.5 wt % to about 99.3 wt %, about 98.5 wt % to about 99.4 wt %, about 98.5 wt % to about 99.5 wt %, about 98.5 wt % to about 99.6 wt %, about 98.5 wt % to about 99.7 wt %, about 98.5 wt % to about 99.8 wt %, about 98.5 wt % to about 99.9 wt %, about 98.6 wt % to about 99.9 wt %, about 98.7 wt % to about 99.9 wt %, about 98.8 wt % to about 99.9 wt %, about 98.9 wt % to about 99.9 wt %, about 99.0 wt % to about 99.9 wt %, about 99.1 wt % to about 99.9 wt %, about 99.2 wt % to about 99.9 wt %, about 99.3 wt % to about 99.9 wt %, about 99.4 wt % to about 99.9 wt %, about 99.5 wt % to about 99.9 wt %, about 99.6 wt % to about 99.9 wt %, about 99.7 wt % to about 99.9 wt %, about 99.8 wt % to about 99.9 wt %, about 98.8 wt % to about 99.7 wt %, about 99.0 wt % to about 99.5 wt %, or about 99.1 wt % to about 99.4 wt %.

The ratio of the catalytic solvent to the spectator solvent in the blend of solvents may be from about 1:10 to about 1:1000 by weight, about 1:11 to about 1:1000 by weight about 1:12 to about 1:1000 by weight, about 1:13 to about 1:1000 by weight, about 1:14 to about 1:1000 by weight, about 1:15 to about 1:1000 by weight, or about 1:16 to about 1:1000 by weight. For example, the ratio of the catalytic solvent to the spectator solvent in the blend of solvents may be from about 1:10 to about 1:100, about 1:15 to about 1:100, about 1:50 to about 1:100, about 1:50 to about 1:250, about 1:50 to about 1:500, about 1:50 to about 1:750, about 1:50 to about 1:1000, about 1:100 to about 1:250, about 1:100 to about 1:500, about 1:100 to about 1:750, about 1:100 to about 1:1000, about 1:250 to about 1:500, about 1:250 to about 1:500, about 1:250 to about 1:750, about 1:250 to about 1:1000, about 1:500 to about 1:750, about 1:500 to about 1:1000, or about 1:750 to about 1:1000 by weight.

The sulfide-based solid electrolyte may comprise less than about 0.5 wt % of the catalytic solvent; i.e., less than about 0.5 wt % of the catalytic solvent is incorporated into the sulfide-based solid electrolyte. As described further herein, drying the sulfide-based solid electrolyte may be performed to remove the catalytic solvent from the sulfide-based solid electrolyte. The sulfide-based solid electrolyte may comprise less than about 0.5 wt %, less than about 0.4 wt %, less than about 0.3 wt %, less than about 0.2 wt %, less than about 0.1 wt %, less than about 0.05 wt %, or less than about 0.01 wt % of the catalytic solvent. For example, the sulfide-based solid electrolyte may comprise about 0.5 wt %, 0.4 wt %, 0.3 wt %, 0.2 wt %, 0.1 wt %, 0.09 wt %, 0.08 wt %, 0.07 wt %, 0.06 wt %, 0.05 wt %, 0.04 wt %, 0.03 wt %, 0.02 wt %, 0.01 wt %, or less than 0.01 wt % of the catalytic solvent.

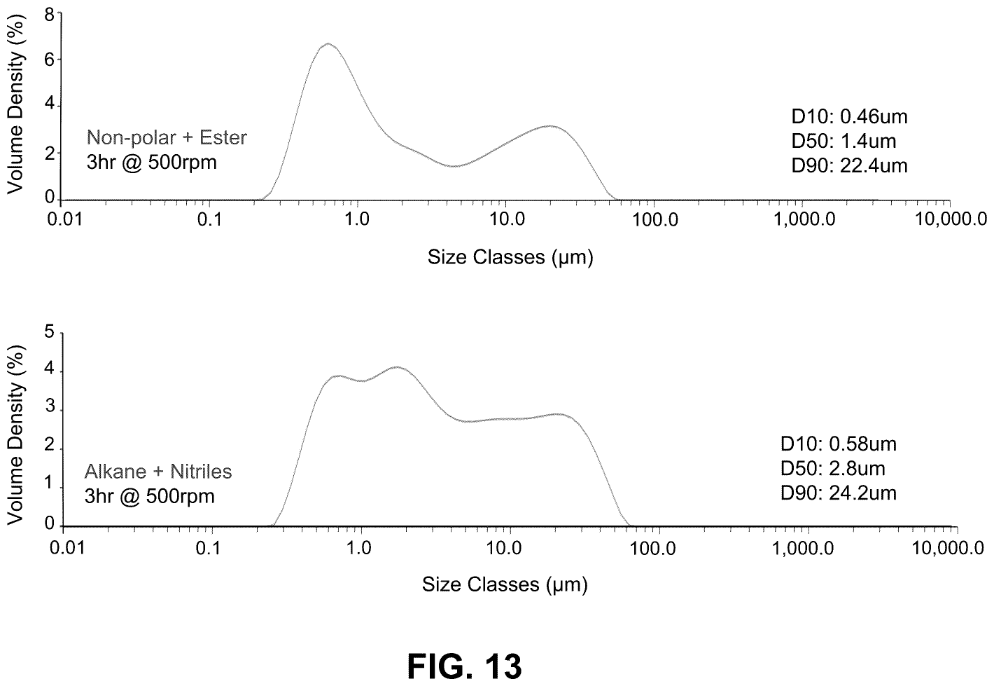

In some embodiments (see, e.g., FIG. 13), the solid electrolyte materials of the present disclosure may have a particle size ranging from about 0.2 μm to about 600 μm with a D₁₀ of 0.46 μm, a D₅₀ of 1.4 μm, and a D₉₀ of 22.4 μm, when the material is synthesized using coordinating and reactive solvents including an ester. The solid electrolyte materials of the present disclosure may have a particle size ranging from about 0.2 μm to about 700 μm with a D₁₀ of 0.58 μm (e.g., a D₁₀ from about 0.55 μm to about 0.65 μm), a D₅₀ of 2.8 μm (e.g., a D₅₀ from about 1.0 μm to about 5.0 μm), and a D₉₀ of 24.2 μm (e.g., a Do from about 15 μm to about 35 μm), when the material is synthesized using coordinating and reactive solvents including a nitrile.

The method may further comprise producing a thiophosphate intermediate formed due to interactions between the precursors and catalytic solvent. The thiophosphate intermediate may comprise PS₄⁻³, P₂S₇⁻⁴, and/or P₂S₆⁴⁻. Generally, the intermediate phase is observed to form prior to the formation of the target phase. The formation of intermediate phases comprised of the same general chemistry as the target phase indicates that the process described herein creates synthesis conditions that facilitate complete reaction of all precursors to produce sulfide-based solid electrolytes with high purity while reducing the time and energy requirements of the synthesis process.

The method may further comprise heating the sulfide-based solid electrolyte. The heating may occur after the removal of the synthesis solvents. The sulfide-based solid electrolyte may be heated to a temperature of about 350° C. to about 550° C. For example, the sulfide-based solid electrolyte may be heated to a temperature of about 350° C. to about 375° C., about 350° ° C. to about 400° C., about 350° C. to about 425° C., about 350° C. to about 450° C., about 350° C. to about 475° C., about 350° C. to about 500° C., about 350° ° C. to about 525° C., about 350° C. to about 550° C., about 375° C. to about 550° C., about 400° C. to about 550° C., about 425° C. to about 550° C., about 450° ° C. to about 550° C., about 475° ° C. to about 550° C., about 500° C. to about 550° C., about 525° C. to about 550° C., or about 400° C. to about 500° C. In other examples, the sulfide-based solid electrolyte may be heated to a temperature of about 350° C., about 375° C., about 400° C., about 425° C., about 450° C., about 475° C., about 500° C., about 525° C., or about 550° C.

The method may comprise heating during synthesis, and may comprise heating after synthesis and/or drying to crystallize. The method may further comprise heating the sulfide-based solid electrolyte a plurality of times. Heating the sulfide-based solid electrolyte material a plurality of times may yield a greater ionic conductivity as compared to a sulfide-based solid electrolyte material heated only once. The sulfide-based solid electrolyte may be heated to a temperature of about 350° C. to about 550° C. during the first and/or subsequent heat treatments. For example, the sulfide-based solid electrolyte may be heated to a temperature of about 350° C. to about 375° C., about 350° C. to about 400° C., about 350° C. to about 425° C., about 350° C. to about 450° C., about 350° ° C. to about 475° C., about 350° C. to about 500° C., about 350° C. to about 525° C., about 350° C. to about 550° ° C., about 375° C. to about 550° C., about 400° C. to about 550° C., about 425° C. to about 550° C., about 450° C. to about 550° C., about 475° C. to about 550° C., about 500° C. to about 550° C., about 525° C. to about 550° C., or about 400° C. to about 500° C. As another example, the sulfide-based solid electrolyte may be heated to a temperature of about 350° C., about 375° C., about 400° C., about 425° C., about 450° C., about 475° C., about 500° C., about 525° C., or about 550° C.

The method may further comprise milling the mixture. The milling may occur before crystallization of the sulfide-based solid electrolyte. The milling may be accomplished using milling apparatuses known in the art. For example, the milling may be accomplished using an autogenous mill, a ball mill, a buhrstone mill, a pebble mill, a rod mill, a semi-autogenous grinding mill, a tower mill, a vertical shaft impactor mill, or other milling apparatuses known in the art. Preferably, the milling is accomplished using a planetary ball mill using zirconia milling media. Shorter milling times are preferred, as it was surprisingly found that shorter overall milling times may result in a solid electrolyte material with a higher ionic conductivity. The shorter milling times may also result in a solid electrolyte material with a larger surface area per particle and/or an increase in surface area contact between the precursor particles or solid electrolyte material particles therein.

The method may further comprise drying the sulfide-based solid electrolyte under vacuum or atmospheric pressure. The drying may be performed in an inert atmosphere, e.g., nitrogen, helium, argon, etc. The drying may be performed to remove any residual catalytic solvent and/or spectator solvent from the sulfide-based solid electrolyte.

The method may result in the production of a sulfide-based solid electrolyte at least two times faster in the presence of the catalytic solvent. The resultant sulfide-based solid electrolyte may comprise an argyrodite phase. The increased speed of production may be compared to the production of a sulfide-based solid electrolyte without the use of a catalytic solvent, or to the production of a sulfide-based solid electrolyte with too little of a catalytic solvent, or to the production of a sulfide-based solid electrolyte with too much of a catalytic solvent. The catalytic solvent may be as low as 0.01% by volume or as high as 50% by volume. When too little catalytic solvent is present the efficiency of synthesis are not improved, and the purity and conductivity of the final product are not improved compared to not using a catalytic solvent. Alternatively, when too much catalytic solvent is present, the slurry of reactants may exhibit rheological properties that lower the efficiency of synthesis and yield products that do not have increased purity or conductivity compared to syntheses not using a catalytic solvent. The limits are defined as the preferred ranges of catalytic solvent described herein. The production of the sulfide-based solid electrolyte may occur up to 25 times faster or more in the presence of the catalytic solvent. In preferred embodiments, the production of the sulfide-based solid electrolyte occurs 4 to 25 times faster in the presence of the catalytic solvent, or more preferably 8 to 25 times faster, 12 to 25 times faster, 16 to 25 times faster, or 20 to 25 times faster in the presence of the catalytic solvent. For example, the production of the sulfide-based solid electrolyte may occur 4 times faster, 5 times faster, 6 times faster, 7 times faster, 8 times faster, 9 times faster, 10 times faster, 11 times faster, 12 times faster, 13 times faster, 14 times faster, 15 times faster, 16 times faster, 17 times faster, 18 times faster, 19 times faster, 20 times faster, 21 times faster, 22 times faster, 23 times faster, 24 times faster, 25 times faster, or more than 25 times faster in the presence of the catalytic solvent.

The method may result in the mixing time of the sulfide-based solid electrolyte precursors being at least two times faster in the presence of the catalytic solvent. The resultant sulfide-based solid electrolyte may comprise an argyrodite phase. The increased speed of mixing may be compared to the mixing of a sulfide-based solid electrolyte without the use of a catalytic solvent, or to the mixing of a sulfide-based solid electrolyte with too little of a catalytic solvent, or to the mixing of a sulfide-based solid electrolyte with too much of a catalytic solvent. When too little catalytic solvent is present, the efficiency of synthesis is not improved, and the purity and conductivity of the final product are not improved compared to not using a catalytic solvent. Alternatively, when too much catalytic solvent is present, the slurry of reactants may exhibit rheological properties that lower the efficiency of synthesis and yield products that do not have increased purity or conductivity compared to syntheses not using a catalytic solvent. The limits are defined as the preferred ranges of catalytic solvent described herein. The mixing time of the sulfide-based solid electrolyte precursors may occur up to 25 times faster or more in the presence of the catalytic solvent. In preferred embodiments, the mixing time of the sulfide-based solid electrolyte precursors may be 4 to 25 times faster in the presence of the catalytic solvent, or more preferably 8 to 25 times faster, 12 to 25 times faster, 16 to 25 times faster, or 20 to 25 times faster in the presence of the catalytic solvent. For example, the mixing time of the sulfide-based solid electrolyte precursors may be 4 times faster, 5 times faster, 6 times faster, 7 times faster, 8 times faster, 9 times faster, 10 times faster, 11 times faster, 12 times faster, 13 times faster, 14 times faster, 15 times faster, 16 times faster, 17 times faster, 18 times faster, 19 times faster, 20 times faster, 21 times faster, 22 times faster, 23 times faster, 24 times faster, 25 times faster, or more than 25 times faster in the presence of the catalytic solvent.

The method may result in the production of the sulfide-based solid electrolyte in less than or equal to 20 hours. The time period of production is measured from the mixing of the precursors to the crystallization of the sulfide-based solid electrolyte. For example, the method may result in the production of the sulfide-based solid electrolyte in 20 hours or less, 19 hours or less, 18 hours or less, 17 hours or less, 16 hours or less, 15 hours or less, 14 hours or less, 13 hours or less, 12 hours or less, 11 hours or less, 10 hours or less, 9 hours or less, 8 hours or less, 7 hours or less, 6 hours or less, 5 hours or less, 4 hours or less, 3 hours or less, 2 hours or less, or 1 hour or less. For example, the method may result in the production of the sulfide-based solid electrolyte in 30 minutes to 1 hour, 1 hour to 2 hours, 1 hour to 4 hours, 1 hour to 6 hours, 1 hour to 8 hours, 1 hour to 12 hours, 2 hours to 4 hours, 2 hours to 6 hours, 2 hours to 8 hours, 2 hours to 12 hours, 4 hours to 8 hours, 4 hours to 12 hours, 8 hours to 12 hours, 8 hours to 16 hours, 12 hours to 16 hours, 16 hours to 20 hours, or 20 hours to 24 hours.

The mixing time of the sulfide-based solid electrolyte precursors may be less than or equal to 20 hours. For example, the mixing time of the sulfide-based solid electrolyte precursors may be 20 hours or less, 19 hours or less, 18 hours or less, 17 hours or less, 16 hours or less, 15 hours or less, 14 hours or less, 13 hours or less, 12 hours or less, 11 hours or less, 10 hours or less, 9 hours or less, 8 hours or less, 7 hours or less, 6 hours or less, 5 hours or less, 4 hours or less, 3 hours or less, 2 hours or less, or 1 hour or less. As another example, the mixing time of the sulfide-based solid electrolyte precursors may be 30 minutes to 1 hour, 1 hour to 2 hours, 1 hour to 4 hours, 1 hour to 6 hours, 1 hour to 8 hours, 1 hour to 12 hours, 2 hours to 4 hours, 2 hours to 6 hours, 2 hours to 8 hours, 2 hours to 12 hours, 4 hours to 8 hours, 4 hours to 12 hours, 8 hours to 12 hours, 8 hours to 16 hours, 12 hours to 16 hours, 16 hours to 20 hours, or 20 hours to 24 hours.

The mixing time of the sulfide-based solid electrolyte precursors may be half (50%) or less in the presence of a catalytic solvent compared to using a spectator solvent only. For example, the mixing time of the sulfide-based solid electrolyte precursors may be about 50%, about 60%, about 70%, about 80%, about 90%, or about 95% less in the presence of a catalytic solvent as compared to using a spectator solvent only. As another example, the mixing time of the sulfide-based solid electrolyte precursors may be about 50% to about 60%, about 50% to about 70%, about 50% to about 80%, about 50% to about 90%, about 50% to about 95%, about 60% to about 95%, about 70% to about 95%, about 80% to about 95%, or about 90% to about 95% less in the presence of a catalytic solvent as compared to using a spectator solvent only.

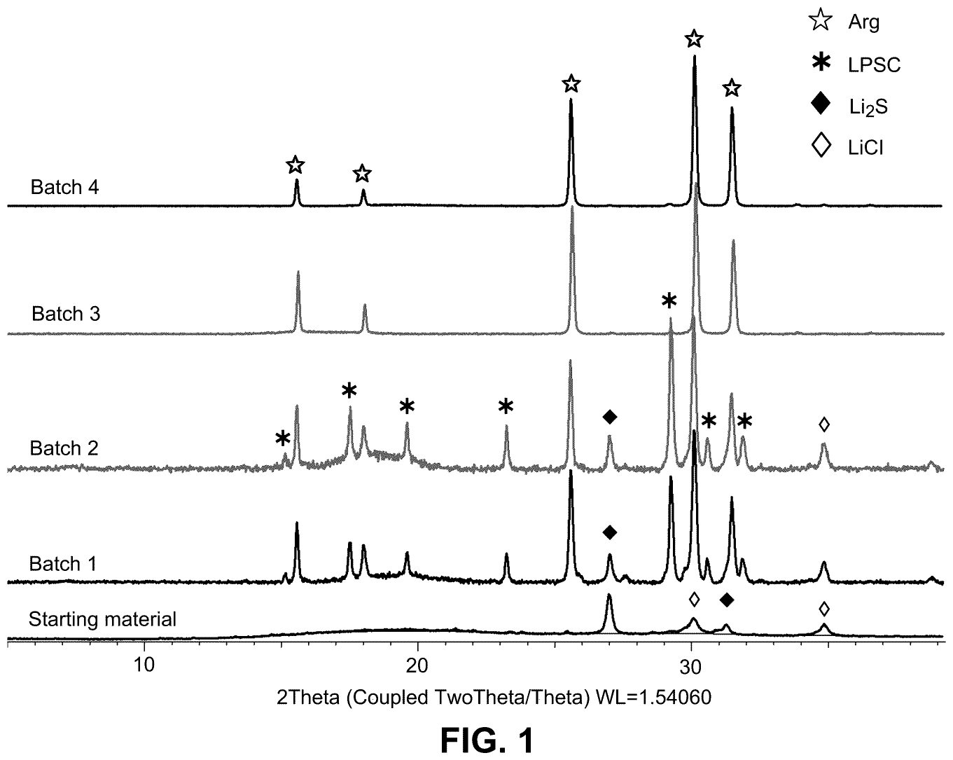

The solid electrolyte materials synthesized using the methods of the present disclosure have characteristic structures that distinguish them from other solid electrolyte materials. In some embodiments, (see, e.g., FIG. 1 of the present disclosure) the solid electrolyte materials may comprise 2 Theta (2θ) values of 15.5°±0.5°, 18.0°±0.5°, 25.5°±0.5°, 30.1±0.5°, and 30.5°±0.5° when using Cuka radiation, which may correspond to Argyrodite phase values, LPSC intermediate phase (Li₁₅P₄S₁₆Cl₃-like phase), Li₂S, and/or LiCl. In particular, the 2 Theta (2θ) values of 15.6°±0.5°, 18.1°±0.5°, 25.7°±0.5°, 30.2°±0.5°, and 31.6°±0.5° may correspond to Argyrodite phase values. In some additional embodiments, the solid electrolyte materials may comprise 2 Theta (2θ) values of 15.6°±0.5°, 17.6°±0.5°, 18.1°±0.5°, 19.6°±0.5°, 23.3°±0.5°, 25.7°±0.5°, 29.3°±0.5°, 30.2°±0.5°, 30.6°±0.5°, 31.9°±0.5°, and 34.8°±0.5°, and may correspond to Argyrodite phase values and/or LPSC intermediate phase values. The solid electrolyte materials may comprise at least three, at least four, or at least five 2 Theta (2θ) values selected from the group consisting of 15.6°±0.5°, 18.1°±0.5°, 25.7°±0.5°, 30.2°±0.5°, and 30.6°±0.5°, and may correspond to Argyrodite phase values. The solid electrolyte materials synthesized using the methods of the present disclosure may comprise at least three, at least four, or at least five 2 Theta (2θ) values selected from the group consisting of 15.6°±0.5°, 17.6°±0.5°, 18.1°±0.5°, 19.6°±0.5°, 23.3°±0.5°, 25.7°±0.5°, 29.3°±0.5°, 30.2°±0.5°, 30.6°±0.5°, 31.9°±0.5°, and 34.8°±0.5°, and may correspond to Argyrodite phase values and/or LPSC intermediate phase values.

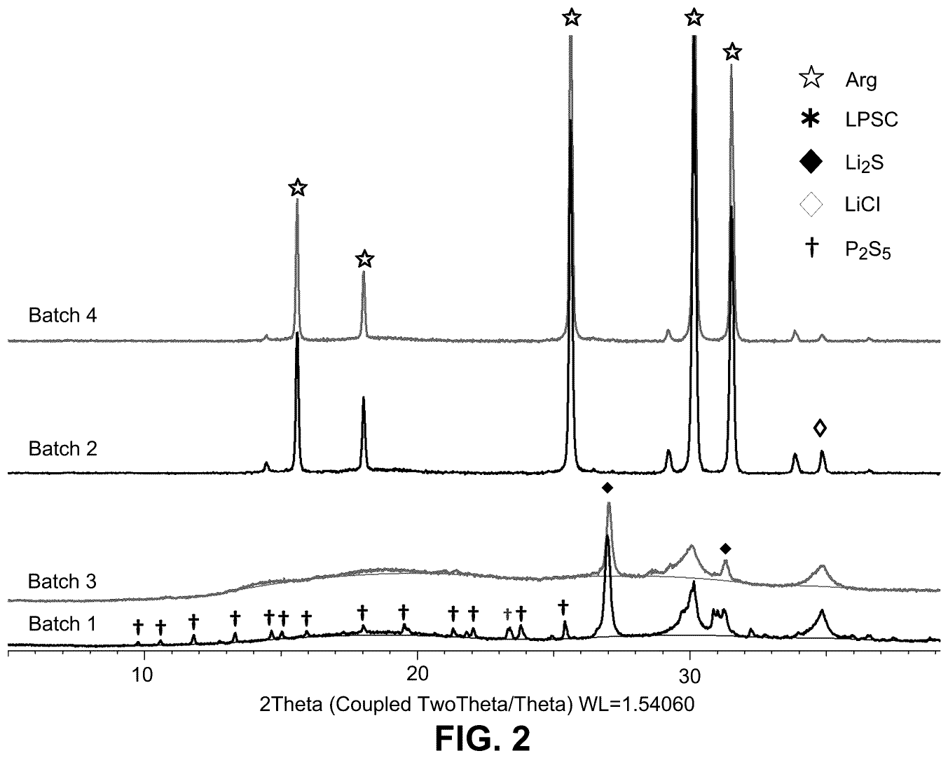

In some embodiments (see, e.g., FIG. 2 of the present disclosure) may comprise 2 Theta (2θ) values of 15.6°±0.5°, 18.1°±0.5°, 25.7°±0.5°, 30.2°±0.5°, 31.6°±0.5°, and 34.8°±0.5°, and may correspond to Argyrodite phase values. The solid electrolyte materials in FIG. 1 may comprise at least three, at least four, or at least five 2 Theta (2θ) values selected from the group consisting of 15.6°±0.5°, 18.1°±0.5°, 25.7°±0.5°, 30.2°±0.5°, 31.6°±0.5°, and 34.8°±0.5°, and may correspond to Argyrodite phase values.

Further provided herein is a composition comprising a sulfide-based solid electrolyte with an Argyrodite phase comprising a catalytic solvent in an amount less than 0.1 wt %. The catalytic solvent may be any catalytic solvent described herein. In preferred embodiments, the catalytic solvent is a nitrile selected from the group consisting of acetonitrile, propionitrile, butyronitrile, isobutyronitrile, benzonitrile, and combinations thereof. In some embodiments, the sulfide-based solid electrolyte may comprise Li₃PS₄.

The sulfide-based solid electrolyte may comprise the catalytic solvent in an amount less than 0.3 wt %, less than 0.2 wt %, less than 0.1 wt %, less than 0.09 wt %, less than 0.08 wt %, less than 0.07 wt %, less than 0.06 wt %, less than 0.05 wt %, less than 0.04 wt %, less than 0.03 wt %, less than 0.02 wt %, or less than 0.01 wt %.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

The term “about” will be understood by persons of ordinary skill in the art and will vary to some extent on the context in which it is used. As used herein when referring to a measurable value such as an amount, a temporal duration, and the like, the term “about” is meant to encompass variations of ±10%, including ±5%, ±1%, and ±0.1% from the specified value, as such variations are appropriate to perform the disclosed methods.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1: Effect of Heat Treatment Conditions on Material—Li₆PS₅Cl

Precursors including 9.4532 g Li₂S, 10.3933 g P₂S₅ (Sigma-Aldrich Co.), and 5.1535 g LiCl (Sigma-Aldrich Co.) were added to a zirconia milling jar with zirconia milling media. 135 mL of heptane and 0.64 mL of isobutyronitrile and 0.28 mL of benzonitrile were added to the same zirconia milling jar. The mixture was milled in a Retsch PM 100 planetary mill for 3 hours at 500 RPM. The material was collected and dried at 90° C. under vacuum.

The material was then split into four batches. In Batch 1, the material was heated to a temperature of 350° C. for 30 minutes. In Batch 2, the material was heated to a temperature of 350° C. for 240 minutes. In Batch 3, the material was heated to a temperature of 350° C. for 240 minutes, followed by additional heating at 450° C. for 30 minutes. In Batch 4, the material was heated to a temperature of 450° C. for 30 minutes.

The starting material and each of the batches were analyzed using X-Ray Diffraction, the results of which are shown in FIG. 1. In Batches 3 and 4, structural differences were detected by the change in peaks at about 2θ=15.5 and 19.6. Moreover, the batches exhibited greater ionic conductivity (4.67 mS/cm and 4.40 mS/cm for Batches 3 and 4, respectively), whereas Batch 1 had an ionic conductivity of only about 0.49 mS/cm. Batch 2 also showed structural differences compared to Batch 1; specifically, more LPSC intermediate phase (Li₁₅P₄S₁₆Cl₃-like phase) was formed in Batch 2 than in Batch 1. As illustrated here, the formation of the LPSC intermediate phase is positively correlated with conductivity of the final target electrolyte phase. Incorporating a nitrile-type catalytic solvent promoted the formation of an LPSC intermediate phase. The development of such an intermediate phase requires good mixing and intimate contact between all of the precursor materials prior to the substantial application of a heat treatment, and it is determined that the use of a nitrile-type catalytic solvent promotes this good contact and intimate mixing.

### Example 2: Effect of Adding Reactive Solvent Later in the Synthesis Process—Li_{5.5}PS_{4.5}Cl_{1.5}

Precursors including 8.6081 g Li₂S, 10.4318 g P₂S₅ (Sigma-Aldrich Co.), and 5.9619 g LiCl (Sigma-Aldrich Co.) were added to a zirconia milling jar with zirconia milling media. 135 mL of xylenes were added to the same zirconia milling jar. The mixture was milled in a Retsch PM 100 planetary mill for 3 hours at 500 RPM. The material was left in the milling jar and dried at 90° C. under vacuum. 135 mL of xylenes were added to the same zirconia milling jar which contained the dried material and the mixture was milled in a Retsch PM 100 planetary mill for 3 hours at 500 RPM. A portion of this material was then collected (Batch 1). The remaining material was cooked at a temperature of 450° C. for 30 minutes. A portion of this material was then collected (Batch 2).

Additional material was prepared for comparison. Precursors including 8.6081 g Li₂S, 10.4318 g P₂S₅ (Sigma-Aldrich Co.), and 5.9619 g LiCl (Sigma-Aldrich Co.) were added to a zirconia milling jar with zirconia milling media. 135 mL of xylenes was added to the same zirconia milling jar. The mixture was milled in a Retsch PM 100 planetary mill for 3 hours at 500 RPM. The material was left in the milling jar and dried at 90° C. under vacuum. 135 ml of xylenes, 0.64 ml of isobutyronitrile, and 0.28 ml of benzonitrile were added to the same zirconia milling jar which contained the dried material and the mixture was milled in a Retsch PM 100 planetary mill for 3 hours at 500 RPM. A portion of this material was then collected (Batch 3). The remaining material was cooked at a temperature of 450° C. for 30 minutes. A portion of this material was then collected (Batch 4).

The batches were then analyzed using X-ray diffraction, the results of which are shown in FIG. 2. FIG. 2 shows that Batch 4 had fewer impurities than Batches 2 as indicated by the smaller peaks at about 2θ=35°. Moreover, the conductivity of Batch 4 (5.8 mS/cm) was greater than the conductivity of Batch 2 (4.2 mS/cm).

This result shows that the nitrile cosolvent improves conductivity even if initial mixing and/or alloying is performed before introducing the nitrile cosolvent. Consequently, the action of the cosolvent is not dependent on milling or mixing, but is separate and complementary to the milling and mixing.

### Example 3: Synthesis of a SSE Material that does not Contain a Halogen—Li₃PS₄

Precursors including 9.5572 g Li₂S and 15.4428 g P₂S₅ (Sigma-Aldrich Co.) were added to a zirconia milling jar with zirconia milling media. 60 mL of xylenes were added to the same zirconia milling jar. The mixture was milled in a Retsch PM 100 planetary mill for 3 hours at 500 RPM. The material was collected and dried at 90° C. under vacuum. A portion of the material was collected (Batch 1). The remaining material was cooked at a temperature of 240° C. for 30 minutes. A portion of this material was then collected (Batch 2).

Precursors including 9.5572 g Li₂S and 15.4428 g P₂S₅ (Sigma-Aldrich Co.) were added to a zirconia milling jar with zirconia milling media. 135 ml of heptane, 0.64 mL of isobutyronitrile and 0.28 mL of benzonitrile were added to the same zirconia milling jar. The mixture was milled in a Retsch PM 100 planetary mill for 3 hours at 500 RPM. The material is collected and dried at 90° C. under vacuum. A portion of the material was collected (Batch 3). The remaining material was cooked at a temperature of 240ºC for 30 minutes. A portion of this material was then collected (Batch 4).

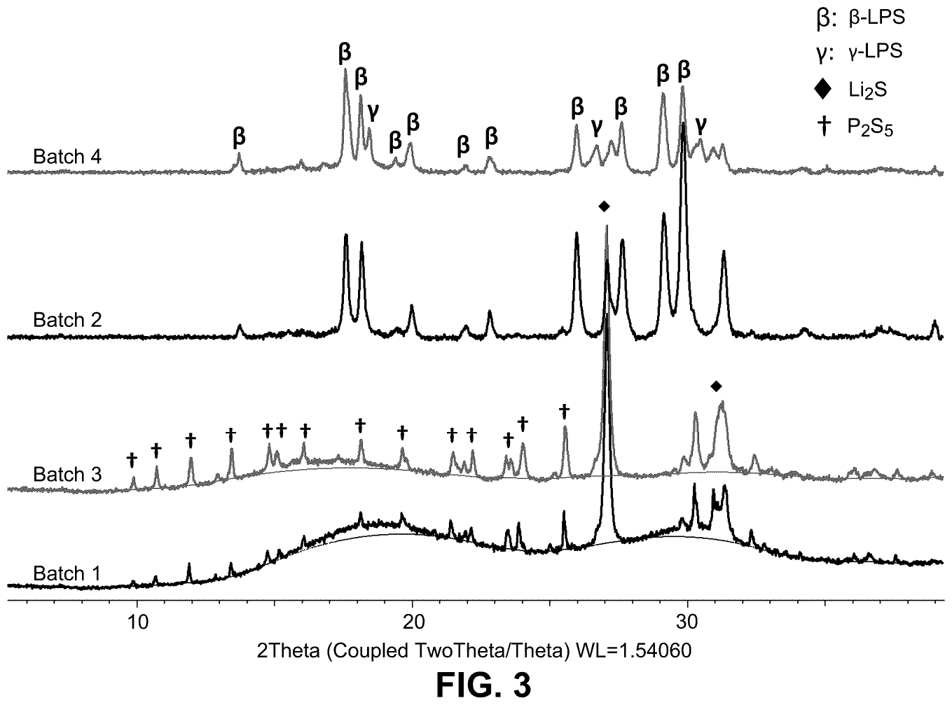

The batches were then analyzed using X-ray diffraction, the results of which are shown in FIG. 3. Differences between materials as-milled (i.e., Batches 1 and 3) are clearly visible in FIG. 3, showing differences in the glassy phase of the materials as evidenced by the differing centroids of the glassy humps in the range 14-24 degrees 2θ. The presence of the coordinating solvents steers the system to the thermodynamically stable products as opposed to other metastable products (i.e., Batch 4 as compared to Batch 2). Specifically, when utilizing a coordinating catalytic solvent, the sulfide-based solid electrolyte materials included both the β- and γ-phases of Li₃PS₄ (LPS), whereas traditional methods of synthesis result solely in the β-phase. The γ-phase of LPS is thermodynamically stable at room temperature, whereas the β-phase is only metastable at room temperature.

### Example 4: Making a Glass Ceramic SSE Using a Nitrile as a Reactive Solvent—Li₇P₂S₈Br_{0.5}I_{0.5}

Precursors including 7.3155 g Li₂S, and 11.8206 P₂S₅ (Sigma-Aldrich Co.), 2.3070 g LiBr (Sigma-Aldrich Co.), and 3.5568 g LiI (Sigma-Aldrich Co.) were added to a zirconia milling jar with zirconia milling media. 60 mL of xylenes were added to the same zirconia milling jar. The mixture was milled in a Retsch PM 100 planetary mill for 3 hours at 500 RPM. The material was collected and dried at 90° C. under vacuum. A portion of the material was collected (Batch 1). The remaining material was cooked at a temperature of 205° C. for 30 minutes. A portion of this material was then collected (Batch 2).

Precursors including 7.3155 g Li₂S, and 11.8206 g P₂S₅ (Sigma-Aldrich Co.), 2.3070 g LiBr (Sigma-Aldrich Co.), and 3.5568 g LiI (Sigma-Aldrich Co.) were added to a zirconia milling jar with zirconia milling media. 135 mL of Heptane, 0.64 mL of Isobutyronitrile and 0.28 mL of Benzonitrile were added to the same zirconia milling jar. The mixture was milled in a Retsch PM 100 planetary mill for 3 hours at 500 RPM. The material was collected and dried at 90° C. under vacuum. A portion of the material was collected (Batch 3). The remaining material was cooked at a temperature of 205° C. for 30 minutes. A portion of this material was then collected (Batch 4).

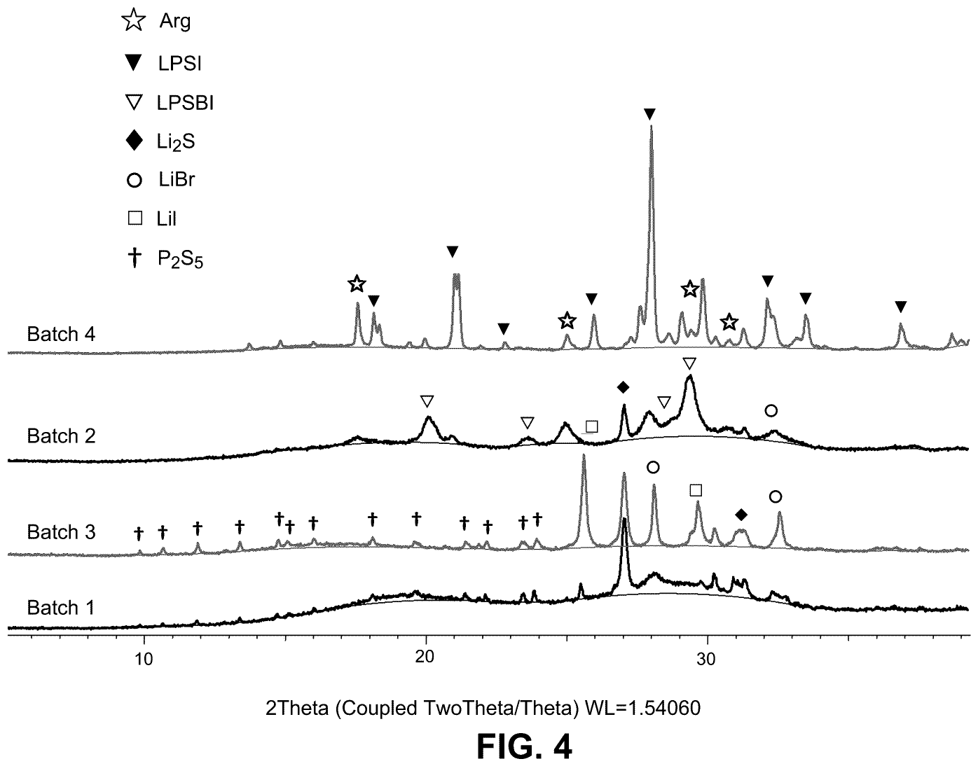

The batches were then analyzed using X-ray diffraction, the results of which are shown in FIG. 4. The results show that the use of reactive solvents steers the system toward thermodynamically stable, high temperature phases such as Argyrodite and Li₄PS₄I (Batches 3 and 4), whereas synthesis with non-reactive solvents produces a glass-ceramic phase (Batches 1 and 2).

Here we demonstrate that the synthesis of a “glass-ceramic” electrolyte is unlikely with this route, and that a “crystalline” electrolyte is more likely to be synthesized. A “glass-ceramic” is a material that contains both glassy and crystalline domains, where the crystalline domains are typically nanosized (<100 nm) and can be considered imbedded in a glassy (amorphous) matrix. Glass-ceramic solid electrolytes are typically synthesized by first creating a glassy mixture of the provided precursors and then applying a subsequent heat treatment to nucleate and/or grow the crystalline domains. Given a particular chemical composition this process typically results in a crystalline phase that is metastable: the given precursors are known to combine to form a different phase with lower free energy, but a phase with higher free energy is instead formed first due to kinetic limitations of crystallization from a glass. In some ways metastable phases may be considered a kinetically stabilized high temperature phase of the given chemical system, and the thermodynamically stable phases might be considered the only existing phase or the phase of lowest free energy of the given chemical system under the given conditions of pressure and temperature.

Here, the synthesis of the known glass-ceramic material with chemistry Li₂P₂S₈Br_{0.5}I_{0.5} was targeted by routes with non-coordinating, non-reactive solvents, and with a solvent blend comprising coordinating or reactive solvents. As seen in the previous example, the use of the coordinating or reactive solvents steer the system towards the thermodynamically stable, high temperature phases (Argyrodite+Li₄PS₄I), while the synthesis with non-coordinating, non-reactive solvents produces the known glass-ceramic phase Li₇P₂S₈Br_{0.5}I_{0.5}.

### Example 5: Duration of Milling and Temperature of Heat Treatment: Synthesis with Non-Coordinating, Non-Reactive Solvents

Precursors including 9.4532 g Li₂S, 10.3922 g P₂S₅ (Sigma-Aldrich Co.), and 5.1535 g LiCl (Sigma-Aldrich Co.) were added to a zirconia milling jar with zirconia milling media. 60 mL of xylenes were added to the same zirconia milling jar. The mixture was milled in a Retsch PM 100 planetary mill for 3 hours at 500 RPM. The material was collected and dried at 90° C. under vacuum.

The material was split into four batches. Batch 1 was cooked at a temperature of 350° C. for 30 minutes. Batch 2 was cooked at a temperature of 400° C. for 30 minutes. Batch 3 was cooked at a temperature of 450° C. for 30 minutes. Batch 4 was cooked at a temperature of 500° ° C. for 30 minutes.

Precursors including 9.4532 g Li₂S, 10.3922 g P₂S₅ (Sigma-Aldrich Co.), and 5.1535 g LiCl (Sigma-Aldrich Co.) were added to a zirconia milling jar with zirconia milling media. 60 mL of xylenes were added to the same zirconia milling jar. The mixture was milled in a Retsch PM 100 planetary mill for 12 hours at 500 RPM. The material was collected and dried at 90° C. under vacuum.

The material was split into four batches. Batch 5 was cooked at a temperature of 350° C. for 30 minutes. Batch 6 was cooked at a temperature of 400° C. for 30 minutes. Batch 7 was cooked at a temperature of 450° C. for 30 minutes. Batch 8 was cooked at a temperature of 500° C. for 30 minutes.

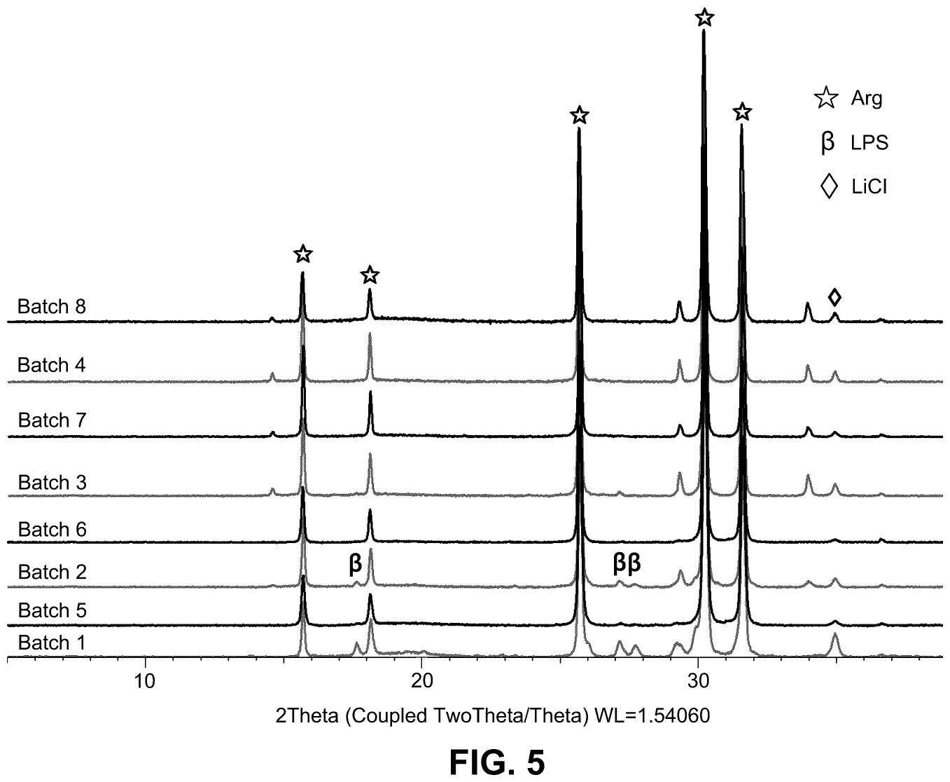

The batches were then analyzed using X-ray diffraction, the results of which are shown in FIG. 5. The ionic conductivity of each batch was also tested, the results for which are shown in FIG. 6. The results showed that longer milling time led to higher phase purity at lower temperatures and higher ionic conductivity overall. Moreover, heat treatment at greater than 400° C. increased the level of impurities and decreased conductivity.

### Example 6: Duration of Milling and Temperature of Heat Treatment: Synthesis with Coordinating or Reactive Solvents Including an Ester

Precursors including 9.4532 g Li₂S, 10.3922 g P₂S₅ (Sigma-Aldrich Co.), and 5.1535 g LiCl (Sigma-Aldrich Co.) were added to a zirconia milling jar with zirconia milling media. 108 mL of xylenes and 32 mL of ethyl propionate were added to the same zirconia milling jar. The mixture was milled in a Retsch PM 100 planetary mill for 3 hours at 500 RPM. The material was collected and dried at 90° C. under vacuum.

The mixture was split into four batches. Batch 1 was cooked at a temperature of 350° C. for 30 minutes. Batch 2 was cooked at a temperature of 400° C. for 30 minutes. Batch 3 was cooked at a temperature of 450° C. for 30 minutes. Batch 4 was cooked at a temperature of 500° ° C. for 30 minutes.

Precursors including 9.4532 g Li₂S, 10.3922 g P₂S₅ (Sigma-Aldrich Co.), and 5.1535 g LiCl (Sigma-Aldrich Co.) were added to a zirconia milling jar with zirconia milling media. 108 mL of xylenes and 32 mL of ethyl propionate were added to the same zirconia milling jar. The mixture was milled in a Retsch PM 100 planetary mill for 12 hours at 500 RPM. The material was collected and dried at 90° C. under vacuum.

The mixture was split into four batches. Batch 5 was cooked at a temperature of 350° C. for 30 minutes. Batch 6 was cooked at a temperature of 400° C. for 30 minutes. Batch 7 was cooked at a temperature of 450° C. for 30 minutes. Batch 8 was cooked at a temperature of 500° ° C. f or 30 minutes.

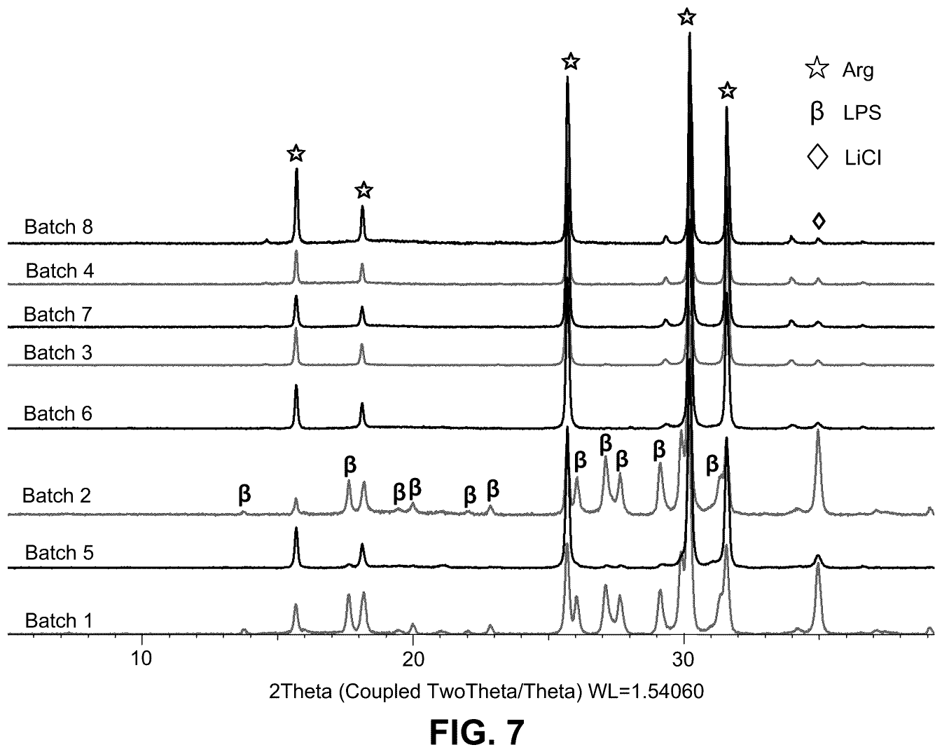

The batches were then analyzed using X-ray diffraction, the results of which are shown in FIG. 7. The ionic conductivity of each batch was also tested, the results for which are shown in FIG. 8. The results showed that longer milling time led to higher phase purity at lower temperatures. The highest overall conductivity was achieved at a shorter milling time. Thus, it could be concluded that the beneficial action of the solvents may be partially negated by long milling times, as low conductivity was observed. Without wishing to be bound by theory, the solvents may increase the surface area of the solids, and milling for an extended duration may reduce the surface area gain.

### Example 7: Duration of Milling and Temperature of Heat Treatment: Synthesis with Coordinating or Reactive Solvents Including a Nitrile

Precursors including 9.4532 g Li₂S, 10.3922 g P₂S₅ (Sigma-Aldrich Co.), and 5.1535 g LiCl (Sigma-Aldrich Co.) were added to a zirconia milling jar with zirconia milling media. 135 mL of heptane, 0.64 mL of isobutyronitrile, and 0.28 mL of benzonitrile were added to the same zirconia milling jar. The mixture was milled in a Retsch PM 100 planetary mill for 3 hours at 500 RPM. The material was collected and dried at 90° C. under vacuum.

The material was split into four batches. Batch 1 was cooked at a temperature of 350° C. for 30 minutes. Batch 2 was cooked at a temperature of 400° C. for 30 minutes. Batch 3 was cooked at a temperature of 450° C. for 30 minutes. Batch 4 was cooked at a temperature of 500° ° C. for 30 minutes.

Precursors including 9.4532 g Li₂S, 10.3922 g P₂S₅ (Sigma-Aldrich Co.), and 5.1535 g LiCl (Sigma-Aldrich Co.) were added to a zirconia milling jar with zirconia milling media. 135 mL of Heptane, 0.64 mL of isobutyronitrile, and 0.28 mL of benzonitrile were added to the same zirconia milling jar. The mixture was milled in a Retsch PM 100 planetary mill for 12 hours at 500 RPM. The material was collected and dried at 90° C. under vacuum.

The material was split into four batches. Batch 5 was cooked at a temperature of 350° ° C. for 30 minutes. Batch 6 was cooked at a temperature of 400° C. for 30 minutes. Batch 7 was cooked at a temperature of 450° C. for 30 minutes. Batch 8 was cooked at a temperature of 500° C. for 30 minutes.

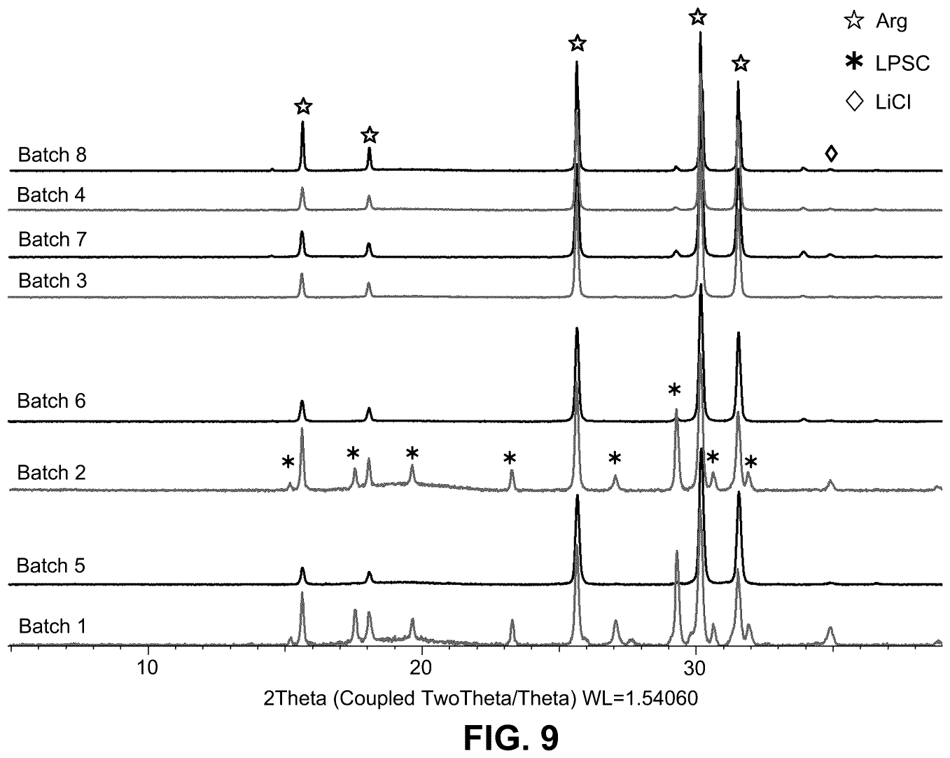

The batches were then analyzed using X-ray diffraction, the results of which are shown in FIG. 9. The ionic conductivity of each batch was also tested, the results for which are shown in FIG. 10. The results show that longer milling leads to higher phase purity at lower temperatures and that the highest overall conductivity was achieved at shorter milling times, consistent with previous results. Additionally, the overall purity and conductivity were improved when using solvents comprising a nitrile.

### Example 8: Ionic Conductivity

FIGS. 11 and 12 show overlays of the ionic conductivity of the electrolyte materials prepared in Examples 5-7. FIG. 11 shows trends in conductivity versus heat treatment temperature for shorter milling times (3 hr), while FIG. 12 shows the same trends for longer milling times (12 hr). It was hypothesized that the coordinating action of the reactive co-solvents creates high surface area upon solvent removal, which facilitates easy and more complete reaction of precursors. Additionally, the nitrile system created an LPSC (also known as LPS-Cl) intermediate which further facilitates halogen uptake and leads to improved conductivity and purity. The nitrile catalytic solvent promotes reaction amongst the precursors and may lead to the best result for purity in the final product.

At longer milling times, improved LiCl incorporation at lower temperatures was observed, which likely was due to better or finer precursor mixing. The low-conducting intermediate phase formation was largely skipped with the longer milling time. Longer milling led to higher conductivity with a xylenes-only solvent system, but lower conductivity with a reactive co-solvent system.

### Example 9: Particle Size

FIG. 13 shows the particle size of the materials made in Examples 6 and 7 milled for 3 hours at 500 rpm. The increases in surface area attributable to the solvent blends may play an important role in the development of high purity and high conductivity. It is also observed that simply creating the highest surface area after milling and solvent removal is not the only important factor determining final product purity and conductivity, as the batch made using ethylpropionate had the highest specific surface area but the batch made with isobutyronitrile/benzonitrile had the highest purity and conductivity.

### Example 10: Temperature During Milling

Precursors including 9.4532 g Li₂S, 10.3933 g P₂S₅ (Sigma-Aldrich Co.), and 5.1535 g LiCl (Sigma-Aldrich Co.) were added to a zirconia milling jar with zirconia milling media. 135 mL of Heptane, 0.64 mL of isobutyronitrile, and 0.28 mL of benzonitrile were added to the same zirconia milling jar. The mixture was milled in a Retsch PM 100 planetary mill for 3 hours at 500 RPM. The material was collected and dried at 90° C. under vacuum.

The material above was split into two batches. Batch 1 was cooked at a temperature of 350° C. for 30 minutes. Batch 2 was cooked at a temperature of 450° C. for 30 minutes.

A second material was synthesized in the same manner as above except the milling conditions were changed. The milling process followed an interval schedule of 2 minutes of milling with 10 minutes of rest, which was repeated over the course of 18 hours. This interval schedule provides 180 minutes of milling and 900 minutes of rest.

The material above was split into two batches. Batch 3 was cooked at a temperature of 350° C. for 30 minutes. Batch 4 was cooked at a temperature of 450° C. for 30 minutes.

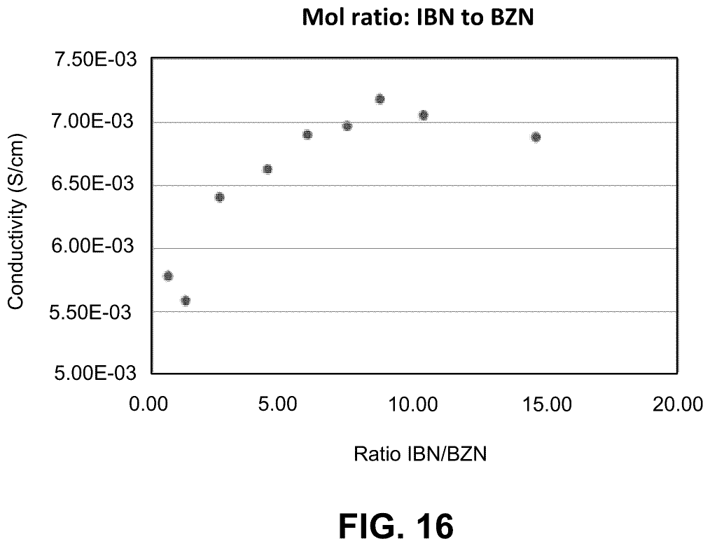

The batches were then analyzed using X-ray diffraction, the results of which are shown in FIG. 16. It can be understood that the interval milling schedule used for Batch 3 and Batch 4 results in lower milling temperatures than the non-interval schedule used in Batch 1 and Batch 2. Therefore, the milling was carried out at different temperatures. As shown in FIG. 16, higher milling temperatures promotes the LPSC intermediate phase development over an LPS intermediate phase development. This may imply that elevated temperatures help the solvent system perform the beneficial action which leads to high purity and high conductivity.

### Examples 11-27: Effect of Composition and Amount of Solvent During Synthesis Process Example 11

Precursors including 8.6081 g Li₂S, 10.4318 g P₂S₅ (Sigma-Aldrich Co.), and 5.9619 g LiCl (Sigma-Aldrich Co.) were added to a zirconia milling jar with zirconia milling media. 135 mL of heptane and 0.64 mL of isobutyronitrile were added to the same zirconia milling jar. The mixture was milled in a Retsch PM 100 planetary mill for 3 hours at 500 RPM. The material was left in the milling jar and dried at 90° C. under vacuum. The material was collected and cooked at a temperature of 450° C. for 30 minutes.

### Example 12

The electrolyte of Example 12 was synthesized in the same way as Example 1 except the 0.64 mL of isobutyronitrile was replaced with 0.30 mL benzonitrile.

### Example 13

The electrolyte of Example 13 was synthesized in the same way as Example 1 except the 0.64 mL of isobutyronitrile was replaced with a blend of 0.64 mL of isobutyronitrile and 0.28 mL benzonitrile.

### Example 14

The electrolyte of Example 14 was synthesized in the same way as Example 1 except the 0.64 mL of isobutyronitrile was replaced with a blend of 0.32 mL of isobutyronitrile and 0.56 mL benzonitrile.

### Example 15

The electrolyte of Example 15 was synthesized in the same way as Example 1 except the 0.64 mL of isobutyronitrile was replaced with a blend of 1.09 mL of isobutyronitrile and 0.28 mL benzonitrile.

### Example 16

The electrolyte of Example 16 was synthesized in the same way as Example 1 except the 0.64 mL of isobutyronitrile was replaced with a blend of 1.46 mL of isobutyronitrile and 0.28 mL benzonitrile.

### Example 17

The electrolyte of Example 17 was synthesized in the same way as Example 1 except the 0.64 mL of isobutyronitrile was replaced with a blend of 1.83 mL of isobutyronitrile and 0.28 mL benzonitrile.

### Example 18

The electrolyte of Example 18 was synthesized in the same way as Example 1 except the 0.64 mL of isobutyronitrile was replaced with a blend of 2.72 mL of isobutyronitrile and 0.28 mL benzonitrile.

### Example 19

The electrolyte of Example 19 was synthesized in the same way as Example 1 except the 0.64 mL of Isobutyronitrile was replaced with a blend of 3.72 mL of isobutyronitrile and 0.28 mL benzonitrile.

### Example 20

The electrolyte of Example 20 was synthesized in the same manner as Example 1 except the 0.64 mL of isobutyronitrile was replaced with a blend 2.14 mL of isobutyronitrile and 0.28 mL benzonitrile.

### Example 21

The electrolyte of Example 21 was synthesized in the same manner as Example 1 except the 0.64 mL of isobutyronitrile was replaced with 1.61 mL of propionitrile.

### Example 22

The electrolyte of Example 22 was synthesized in the same manner as Example 1 except the 0.64 mL of isobutyronitrile was replaced with a blend 1.21 mL of propionitrile and 0.28 mL benzonitrile.

### Example 23

The electrolyte of Example 23 was synthesized in the same manner as Example 1 except the 0.64 mL of isobutyronitrile was replaced with a blend 1.61 mL of propionitrile and 0.28 mL benzonitrile.

### Example 24

The electrolyte of Example 24 was synthesized in the same manner as Example 1 except the 0.64 of isobutyronitrile was replaced with a blend 2.42 mL of propionitrile and 0.28 mL benzonitrile.

### Example 25

The electrolyte of Example 25 was synthesized in the same manner as Example 12 except the 0.28 mL benzonitrile was replaced with 0.56 benzonitrile.

### Example 26

The electrolyte of Example 26 was synthesized in the same manner as Example 12 except the 0.28 mL benzonitrile was replaced with 24.55 mL and the amount of heptane used was reduced from 135 mL to 110.45 mL.

### Example 27

The electrolyte of Example 27 was synthesized in the same manner as Example 12 except the 0.28 mL benzonitrile was replaced with 48.1 mL and the amount of heptane used was reduced from 135 mL to 86.9 mL.

Table 1 summarizes the solid electrolytes made using IBN and BZN solvent blend composition and the corresponding conductivity of Examples 11-20.

Table 2 summarizes the solid electrolytes made using PrN and BZN solvent blend composition and the corresponding conductivity of Examples 21-24.

Table 3 summarizes the solid electrolytes made using IBN and BZN solvent blend composition, ratio of solvent to phosphorous starting material, and the corresponding conductivity of Examples 11-20.

Table 4 summarizes the solid electrolytes made using IBN and BZN solvent blend composition, ratio of solvent to phosphorous starting material, and the corresponding conductivity of Examples 21-24.

### Effect of Amount of Nitrile Solvent on Electrolyte Conductivity

The conductivity of electrolytes of Example 12 and 25-27 was measured and the results are presented in Table 5.

In Examples 12 and 25-27 a blend of two solvents were used during the synthesis process of solid electrolyte where one solvent is a spectator solvent and the other solvent is a nitrile based solvent. In Example 27, the nitrile solvent was used in the amount of around 39 wt % of the total solvent used and the electrolyte material made in this example had an ionic conductivity of 5.56 mS/cm. In Example 26, the nitrile solvent was used in the amount of around 19.5 wt % of the total solvent used and the electrolyte material made in this example had an ionic conductivity of 3.78 mS/cm. In Example 25, the nitrile solvent is used in the amount of around 0.44 wt % of the total solvent used and the electrolyte material made in this example had an ionic conductivity of 5.14 mS/cm. In Example 12, the nitrile solvent is used in the amount of around 0.22 wt % of the total solvent used and the electrolyte material made in this example had an ionic conductivity of 5.82 mS/cm.

As shown by the conductivities of the electrolytes of Example 27 to Example 26, larger quantities of a nitrile solvent produced an electrolyte material with a higher ionic conductivity of 5.56 mS/cm when using 39 wt % nitrile solvent vs 3.78 mS/cm when using 19.5 wt %. This result alone is motivation to use larger quantities of nitriles. However, an unexpected result occurs when notably lowering the quantity of nitrile solvent. When using a nitrile solvent in the amount of 0.44 wt % as in Example 25, the ionic conductivity jumps to 5.14 mS/cm. Even more surprising, when further lowering the amount of nitrile solvent used to just 0.22% as in Example 12, the ionic conductivity of the electrolyte material is increased by over 10% to 5.82 mS/cm. This result is unexpected and has not been previously reported.

### Effect of a Blend of Nitrile Solvents on Electrolyte Conductivity

In Example 21, an aliphatic nitrile solvent (propionitrile, PrN) was used in combination with a spectator solvent to produce a solid electrolyte material having an ionic conductivity of 4.37 mS/cm. In Example 26, an aromatic nitrile solvent (benzonitrile, BZN) was used in combination with a spectator solvent (heptane) to produce a solid electrolyte material having an ionic conductivity of 3.78 mS/cm. In Example 24, an aliphatic nitrile solvent (PrN) and an aromatic nitrile (BZN) solvent were used in combination with a spectator solvent to produce a solid electrolyte material having an ionic conductivity of 5.27 mS/cm. The use of a blend of nitrile solvents where at least one nitrile solvent is aliphatic and at least one nitrile solvent is aromatic produces an electrolyte material with an ionic conductivity that is superior to the same electrolyte material made using only one aliphatic nitrile solvent or only one aromatic nitrile solvent.

TABLE 1
Solid electrolytes made by IBN and BZN solvent blend and the corresponding conductivity
of Examples 11-20. The volume, mass, and molar ratio of the solvents is provided.

| | | | Alkyl | Aryl | | Alkyl | Aryl | | Alkyl | Aryl | |
|---|---|---|---|---|---|---|---|---|---|---|---|
| | | Spectator | catalytic | catalytic | | catalytic | catalytic | | catalytic | catalytic | |
| | | Solvent | solvent | solvent | Volume | solvent | solvent | Mass | solvent | solvent | Molar |
| | Conductivity | Heptane | IBN | BZN | Ratio | IBN | BZN | Ratio | BZN | BZN | Ratio |
| | (mS/cm) | (mL) | (mL) | (mL) | IBN/BZN | (g) | (g) | IBN/BZN | (mol) | (mol) | IBN/BZN |
| Example 11 | 4.25 | 135 | 0.64 | 0 | NA | 0.4931 | 0 | 0 | 0.0071 | 0.0000 | NA |
| Example 12 | 5.82 | 135 | 0 | 0.3 | 0 | 0 | 0.2826 | 0 | 0 | 0.0027 | 0 |
| Example 13 | 6.39 | 135 | 0.64 | 0.28 | 2.29 | 0.4931 | 0.2826 | 1.74 | 0.0071 | 0.0027 | 2.60 |
| Example 14 | 5.78 | 135 | 0.32 | 0.56 | 0.57 | 0.2465 | 0.5652 | 0.44 | 0.0036 | 0.0055 | 0.65 |
| Example 15 | 6.61 | 135 | 1.09 | 0.28 | 3.89 | 0.8397 | 0.2826 | 2.97 | 0.0122 | 0.0027 | 4.43 |
| Example 16 | 6.88 | 135 | 1.46 | 0.28 | 5.21 | 1.1248 | 0.2826 | 3.98 | 0.0163 | 0.0027 | 5.94 |
| Example 17 | 6.95 | 135 | 1.83 | 0.28 | 6.54 | 1.4098 | 0.2826 | 4.99 | 0.0204 | 0.0027 | 7.44 |
| Example 18 | 7.04 | 135 | 2.72 | 0.28 | 9.71 | 2.0955 | 0.3028 | 6.92 | 0.0303 | 0.0029 | 10.33 |
| Example 19 | 6.86 | 135 | 3.72 | 0.29 | 12.83 | 2.8659 | 0.2927 | 9.79 | 0.0415 | 0.0028 | 14.61 |
| Example 20 | 7.16 | 135 | 2.14 | 0.28 | 7.64 | 1.6487 | 0.2826 | 5.83 | 0.0239 | 0.0027 | 8.70 |

TABLE 2
Solid electrolytes made by PrN and BZN solvent blend and the corresponding conductivity
of Examples 11-20. The volume, mass, and molar ratio of the solvents is provided.

| | | | Alkyl | Aryl | | Alkyl | Aryl | | Alkyl | Aryl | |
|---|---|---|---|---|---|---|---|---|---|---|---|
| | | Spectator | catalytic | catalytic | | catalytic | catalytic | | catalytic | catalytic | |
| | | Solvent | solvent | solvent | Volume | solvent | solvent | Mass | solvent | solvent | Molar |
| | Conductivity | Heptane | PrN | BZN | Ratio | PrN | BZN | Ratio | PrN | BZN | Ratio |
| | (mS/cm) | (mL) | (mL) | (mL) | PrN/BZN | (g) | (g) | PrN/BZN | (mol) | (mol) | IBN/BZN |
| Example 21 | 4.37 | 135 | 1.6 | 0 | 0 | 1.28 | 0 | 0 | 0.0233 | 0.0000 | 0 |
| Example 22 | 4.86 | 135 | 1.2 | 0.3 | 4.00 | 0.96 | 0.3028 | 3.18 | 0.0175 | 0.0029 | 6.03 |
| Example 23 | 5.12 | 135 | 1.6 | 0.3 | 5.33 | 1.28 | 0.3028 | 4.24 | 0.0233 | 0.0029 | 8.03 |
| Example 24 | 5.27 | 135 | 2.4 | 0.3 | 8.00 | 1.92 | 0.3028 | 6.36 | 0.0349 | 0.0029 | 12.03 |

TABLE 3
Solid electrolytes made IBN and BZN solvent blend, ratio of solvent to phosphorous
starting material, and the corresponding conductivity of Examples 11-20.
The volume, mass, and molar ratio of the solvents is provided.

| | | | Alkyl | Aryl | | | |
|---|---|---|---|---|---|---|---|
| | | Spectator | catalytic | catalytic | | | |
| | | Solvent | solvent | solvent | Molar | Molar | Molar |
| | Conductivity | Heptane | BZN | BZN | Ratio | Ratio | Ratio |
| | (mS/cm) | (mL) | (mol) | (mol) | IBN/BZN | IBN/P4S10 | BZN/P4S10\| |
| Example 11 | 4.25 | 135 | 0.0071 | 0.0000 | NA | 0.02 | NA |
| Example 12 | 5.82 | 135 | 0 | 0.0027 | 0 | 0 | 0.01 |
| Example 13 | 6.39 | 135 | 0.0071 | 0.0027 | 2.60 | 0.02 | 0.01 |
| Example 14 | 5.78 | 135 | 0.0036 | 0.0055 | 0.65 | 0.01 | 0.02 |
| Example 15 | 6.61 | 135 | 0.0122 | 0.0027 | 4.43 | 0.04 | 0.01 |
| Example 16 | 6.88 | 135 | 0.0163 | 0.0027 | 5.94 | 0.05 | 0.01 |
| Example 17 | 6.95 | 135 | 0.0204 | 0.0027 | 7.44 | 0.06 | 0.01 |
| Example 18 | 7.04 | 135 | 0.0303 | 0.0029 | 10.33 | 0.09 | 0.01 |
| Example 19 | 6.86 | 135 | 0.0415 | 0.0028 | 14.61 | 0.13 | 0.01 |
| Example 20 | 7.16 | 135 | 0.0239 | 0.0027 | 8.70 | 0.07 | 0.01 |

TABLE 4
Solid electrolytes made PrN (alkyl) and BZN (aryl) solvent blend, ratio of solvent
to phosphorous starting material, and the corresponding conductivity of Examples
21-24. The volume, mass, and molar ratio of the solvents is provided.

| | | | Alkyl | Aryl | | | |
|---|---|---|---|---|---|---|---|
| | | Spectator | catalytic | catalytic | | | |
| | | Solvent | solvent | solvent | Molar | Molar | Molar |
| | Conductivity | Heptane | PrN | BZN | Ratio | Ratio | Ratio |
| | (mS/cm) | (mL) | (mol) | (mol) | PrN/BZN | PrN/P4S10 | BZN/P4S10 |
| Example 21 | 4.37 | 135 | 0.0233 | 0.0000 | 0 | 0.99 | 0 |
| Example 22 | 4.86 | 135 | 0.0175 | 0.0029 | 6.03 | 0.05 | 0.01 |
| Example 23 | 5.12 | 135 | 0.0233 | 0.0029 | 8.03 | 0.07 | 0.01 |
| Example 24 | 5.27 | 135 | 0.0349 | 0.0029 | 12.03 | 0.11 | 0.01 |

TABLE 5
Solid electrolytes made by different amounts of BZN solvent,
ratio of solvent to phosphorous starting material, and
the corresponding conductivity of Examples 12, 25-27.

| | Conductivity | Heptane | BZN | BZN | BZN | BZN/ |
|---|---|---|---|---|---|---|
| | (mS/cm) | (mL) | (mL) | (g) | (mol) | P4S10 |
| Example 12 | 5.82 | 135 | 0.3 | 0.2826 | 0.0027 | 0 |
| Example 25 | 5.14 | 135 | 0.6 | 0.5652 | 0.0054 | 0.02 |
| Example 26 | 3.78 | 135 | 26.3 | 24.7746 | 0.2367 | 0.74 |
| Example 27 | 5.56 | 135 | 52.6 | 49.5492 | 0.4734 | 1.48 |

### Varying the Molar Ratio of Aliphatic Nitrile Solvent to Aromatic Nitrile Solvent

In Example 13, the ratio between the molar amount of aliphatic nitrile (IBN) solvent to aromatic nitrile (BZN) solvent used to produce a solid electrolyte material was 2.6. The resulting solid electrolyte material had an ionic conductivity of 6.39 mS/cm.

In Example 15, the ratio between the molar amount of aliphatic nitrile (IBN) solvent to aromatic nitrile (BZN) solvent used to produce a solid electrolyte material was 4.34. The resulting solid electrolyte material had an ionic conductivity of 6.61 mS/cm.

In Example 17, the ratio between the molar amount of aliphatic nitrile (IBN) solvent to aromatic nitrile (BZN) solvent used to produce a solid electrolyte material was 7.44. T The resulting solid electrolyte material had an ionic conductivity of 6.95 mS/cm.

In Example 19, the ratio between the molar amount of aliphatic nitrile (IBN) solvent to aromatic nitrile (BZN) solvent used to produce a solid electrolyte material was 14.61. The resulting solid electrolyte material had an ionic conductivity of 6.86 mS/cm.

The data shows indicates that when the ratio of (X) the mols of the aliphatic nitrile solvent used during synthesis and (Y) the mols of the aromatic nitrile solvent used during synthesis is between 1 and 15, a solid electrolyte with high ionic conductivity was be produced. A graphical representation of this result is depicted in FIG. 16.

Varying the Molar Ratio of Aromatic Nitrile Solvent (Benzonitrile) to P₂S₅ Between 0.05 and 0.5

In Example 11, the ratio between the molar amount of aromatic nitrile solvent (benzonitrile) and the molar amount of P₂S₅ used to produce a solid electrolyte material was less than 0.05. The resulting solid electrolyte material had an ionic conductivity of 4.25 mS/cm.

In Example 14, the ratio between the molar amount of aromatic nitrile solvent (benzonitrile) and the molar amount of P₂S₅ used to produce a solid electrolyte material was approximately 0.04. The solid electrolyte material resulting from Example 14 had an ionic conductivity of 5.78 mS/cm.

In Example 13, the ratio between the molar amount of aromatic nitrile solvent (benzonitrile) and the molar amount of P₂S₅ used to produce a solid electrolyte material was approximately 0.02. The resulting solid electrolyte material had an ionic conductivity of 6.39 mS/cm.

In Example 26, the ratio between the molar amount of aromatic nitrile solvent (benzonitrile) and the molar amount of P₂S₅ used to produce a solid electrolyte material was greater than 1.00. The resulting solid electrolyte material had an ionic conductivity of 3.78 mS/cm.

Examples 11, 13, 14, and 26 shows that when the ratio of (A) the molar amount of aromatic nitrile (benzonitrile) and (B) the molar amount of P₂S₅ used during synthesis is between 0.05 and 0.5, a solid electrolyte with high ionic conductivity is produced.

### Enumerated Embodiment

The present disclosure relates to a method for producing a sulfide-based solid electrolyte comprising mixing an alkali metal sulfide or an alkaline earth metal sulfide, a secondary sulfide, and optionally an alkali halide or pseudohalide to produce a sulfide-based solid electrolyte, wherein the mixing occurs in a blend of solvents comprising a catalytic solvent and a spectator solvent, and crystallizing the sulfide-based solid electrolyte.

In some embodiments, the method further may include mixing the alkali halide, the alkali halide comprising LiX where X may be one or more of F, Cl, Br, and I. In some embodiments, the alkali metal sulfide may comprise A₂S where A may be one or more of Li and Na. In some embodiments, the secondary sulfide may comprise one or more of P₂S₅, SiS₂, Sb₂S₃, GeS₂, SnS₂. In some embodiments, the sulfide-based solid electrolyte may comprise an Argyrodite phase. In some embodiments, the sulfide-based solid electrolyte may be at least 90% pure (wt %). In some embodiments, the sulfide-based solid electrolyte may comprise at least 85% crystalline phase. In some embodiments, the crystalline phase may be metastable. In some embodiments, the sulfide-based solid electrolyte may comprise less than 1% LiCl.

In some embodiments, the sulfide-based solid electrolyte may comprise less than 1% Li₂S.

In some embodiments, the sulfide-based solid electrolyte may comprise an Argyrodite phase, the alkali metal sulfide comprises Li₂S, the secondary sulfide comprises P₂S₅, and the alkali halide, when present, comprises Lix, and wherein X═F, Cl, Br, or I.

In some embodiments, the catalytic solvent may be 0.1 to 6 wt % of the blend of solvents.

In some embodiments, the catalytic solvent may be 0.3 to 4.5 wt % of the blend of solvents.

In some embodiments, the catalytic solvent may be 0.5 to 3 wt % of the blend of solvents.

In some embodiments, the catalytic solvent may be 0.6 to 0.9 wt % of the blend of solvents.

In some embodiments, the spectator solvent may be 94.0 to 99.9 wt % of the blend of solvents.

In some embodiments, the spectator solvent may be 98.5 to 99.9 wt % of the blend of solvents.

In some embodiments, the catalytic solvent may comprise one or more nitrile solvents.

In some embodiments, the one or more nitrile solvents may be selected from the group consisting of acetonitrile, propionitrile, butyronitrile, isobutyronitrile, benzonitrile, and combinations thereof.

In some embodiments, the catalytic solvent comprises an aryl solvent substituted with one or more nitrile groups, an alkyl solvent substituted with one or more nitrile groups, or a combination thereof.

In some embodiments, the aryl solvent substituted with one or more nitrile groups and the secondary sulfide may be present in a mol ratio from about 0.5:1 to about 1.5:1.

In some embodiments, a combination of the aryl solvent substituted with one or more nitrile groups and the alkyl solvent substituted with one or more nitrile groups and the secondary sulfide may be present in a mol ratio from about 0.5:1 to about 1.5:1.

In some embodiments, the alkyl solvent substituted with one or more nitrile groups and the aryl solvent substituted with one or more nitrile groups may be present in a volume ratio from about 5:1 to about 10:1.

In some embodiments, the alkyl solvent substituted with one or more nitrile groups and the aryl solvent substituted with one or more nitrile groups may be present in a mass ratio from about 4:1 to about 8:1.

In some embodiments, the alkyl solvent substituted with one or more nitrile groups and the aryl solvent substituted with one or more nitrile groups may be present in a mol ratio from about 6:1 to about 12:1.

In some embodiments, the spectator solvent may comprise a hydrocarbon-based solvent.

In some embodiments, the spectator solvent may comprise an alkane or blend of alkanes, xylene, toluene, benzene, decalin, 1,2,3,4-tetrahydronaphthalene, or combinations thereof.

In some embodiments, the method further comprises heating the sulfide-based solid electrolyte.

In some embodiments, the sulfide-based solid electrolyte may be heated to a temperature of about 350° ° C. to about 550° C.

Some embodiments of the method further comprise milling the mixture.

Some embodiments of the method further comprise drying the sulfide-based solid electrolyte under vacuum or atmospheric pressure.

Some embodiments of the method may further comprise producing a thiophosphate intermediate.

In some embodiments, the thiophosphate intermediate may comprise P₂S₆⁴⁻ and/or PS(₄₋ₓ)Oₓ, wherein x may be between 0 and 4. In some embodiments, the thiophosphate intermediate may comprise PS₄³⁻. In some embodiments, the thiophosphate intermediate may comprise P₂S₇⁴⁻.

In some embodiments, the sulfide-based solid electrolyte may comprise Li₃PS₄. In some embodiments, the Li₃PS₄ may be crystalline. In some embodiments, the Li₃PS₄ may be amorphous.

In some embodiments, the sulfide-based solid electrolyte may comprise fewer impurities as compared to a sulfide-based solid electrolyte prepared with a non-coordinating non-reactive solvent.

In some embodiments, the sulfide-based solid electrolyte may have at least a 25% greater ionic conductivity as compared to a sulfide-based solid electrolyte prepared with a non-coordinating non-reactive solvent.

In some embodiments, the use of a catalytic solvent results in a sulfide-based solid electrolyte that may be at least about 90% crystalline.

The present disclosure further relates to a method for producing a sulfide-based solid electrolyte with an Argyrodite phase comprising mixing sulfide-based solid electrolyte precursors comprising Li₂S, P₂S₅, and LiX in a blend of solvents comprising a catalytic solvent and a spectator solvent to produce a sulfide-based solid electrolyte, wherein X═F, Cl, Br, or I; and crystallizing the sulfide-based solid electrolyte, wherein the required mixing time of the sulfide-based solid electrolyte precursors may be half (50%) or less in the presence of the catalytic solvent compared to using a spectator solvent only.

In some embodiments, the production of the sulfide-based solid electrolyte may occur 4 to 25 times faster in the presence of the catalytic solvent.

The present disclosure further relates to a method for producing a sulfide-based solid electrolyte comprising mixing sulfide-based solid electrolyte precursors comprising Li₂S, P₂S₅, and LiX in a blend of solvents comprising a catalytic solvent and a spectator solvent to produce a sulfide-based solid, wherein X═F, Cl, Br, I; and crystallizing the sulfide-based solid electrolyte, wherein the mixing time of the sulfide-based solid electrolyte precursors may be less than 20 hours.

In some embodiments, the mixing time of the sulfide-based solid electrolyte precursors may be less than 15 hours.

In some embodiments, the mixing time of the sulfide-based solid electrolyte precursors may be less than 10 hours.

In some embodiments, the mixing time of the sulfide-based solid electrolyte precursors may be less than 8 hours.

In some embodiments, the mixing time of the sulfide-based solid electrolyte precursors may be less than 6 hours.

In some embodiments, the mixing time of the sulfide-based solid electrolyte precursors may be less than 5 hours.

In some embodiments, the sulfide-based solid electrolyte may comprise an Argyrodite phase. In some embodiments, the sulfide-based solid electrolyte may be at least 90% pure (wt %). In some embodiments, the sulfide-based solid electrolyte may comprise at least 60% crystalline phase. In some embodiments, the crystalline phase may be metastable. In some embodiments, the sulfide-based solid electrolyte may comprise less than 1% LiCl. In some embodiments, the sulfide-based solid electrolyte may comprise less than 1% Li₂S.

The present disclosure further relates to a method for producing a sulfide-based solid electrolyte with an Argyrodite phase comprising mixing Li₂S, P₂S₅, and LiX in a blend of solvents comprising a catalytic solvent and a spectator solvent to produce a sulfide-based solid electrolyte with an Argyrodite phase, wherein X═F, Cl, Br, or I; and crystallizing the sulfide-based solid electrolyte, wherein less than 15% (wt %) of the sulfide-based solid electrolyte may be in a amorphous phase.

The present disclosure further relates to a composition comprising a Li₃PS₄ and a thiophosphate comprising one or more of PS₄ and P₂S₇ and P₂S₆ and an Argyrodite phase, wherein the composition comprises from 0.01 to 0.90 wt % of a nitrile selected from the group consisting of acetonitrile, propionitrile, butyronitrile, isobutyronitrile, benzonitrile, and combinations thereof.

In some embodiments, less than 15% (wt %) of the thiophosphate may be in a amorphous phase.

The present disclosure further relates to a method for producing a sulfide-based solid electrolyte with an Argyrodite phase comprising mixing Li₂S, P₂S₅, and LiX in a blend of solvents comprising a catalytic solvent and a spectator solvent to produce a sulfide-based solid electrolyte with an Argyrodite phase, wherein X═F, Cl, Br, or I, and the ratio of catalytic solvent to spectator solvent may be from 1:15 to 1:1000 by weight; and crystallizing the sulfide-based solid electrolyte

The present disclosure further relates to a method for producing a sulfide-based solid electrolyte with an Argyrodite phase comprising mixing Li₂S, P₂S₅, and LiX to produce a sulfide-based solid electrolyte with an Argyrodite phase, wherein the mixing occurs in a blend of solvents comprising a catalytic solvent and a spectator solvent, and X═F, Cl, Br, or I; and, crystallizing the sulfide-based solid electrolyte with less than 0.5 wt % of catalytic solvent incorporated into the sulfide-based solid electrolyte.

The present disclosure further relates to a composition comprising a sulfide-based solid electrolyte with an Argyrodite phase comprising a nitrile selected from the group consisting of acetonitrile, propionitrile, butyronitrile, isobutyronitrile, benzonitrile, and combinations thereof, in amount less than 0.1 wt %. In some embodiments, less than 0.05 wt % of the nitrile may be incorporated into the sulfide-based solid electrolyte. In some embodiments, less than 0.01 wt % of the nitrile may be incorporated into the sulfide-based solid electrolyte. In some embodiments, less than 0.001 wt % of the nitrile may be incorporated into the sulfide-based solid electrolyte.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. A method for producing a sulfide-based solid electrolyte comprising:
mixing an alkali metal sulfide and/or an alkaline earth metal sulfide, a secondary sulfide, and optionally an alkali halide or pseudohalide to produce a sulfide-based solid electrolyte, wherein the mixing occurs in a blend of solvents comprising a catalytic solvent and a spectator solvent, and crystallizing the sulfide-based solid electrolyte.

2. The method of claim 1, further comprising mixing the alkali halide, the alkali halide comprising LiX where X is one or more of F, Cl, Br, and I.

3. The method of claim 1, wherein the alkali metal sulfide comprises A₂S where A is one or more of Li and Na.

4. The method of claim 1, wherein the secondary sulfide comprises one or more of P₂S₅, SiS₂, Sb₂S₃, GeS₂, SnS₂.

5. The method of claim 1, wherein the sulfide-based solid electrolyte comprises less than 1 wt % LiCl or less than 1 wt % Li₂S.

6. The method of claim 1, wherein the sulfide-based solid electrolyte comprises an Argyrodite phase, the alkali metal sulfide comprises Li₂S, the secondary sulfide comprises P₂S₅, and the alkali halide, when present, comprises LiX, and wherein X═F, Cl, Br, or I.

7. The method of claim 1, wherein the catalytic solvent is 0.1 to 6 wt % of the blend of solvents.

8. The method of claim 1, wherein the spectator solvent is 94.0 to 99.9 wt % of the blend of solvents.

9. The method of claim 1, wherein the catalytic solvent comprises one or more nitrile solvents.

10. The method of claim 9, wherein the one or more nitrile solvents may be selected from the group consisting of acetonitrile, propionitrile, butyronitrile, isobutyronitrile, benzonitrile, and combinations thereof.

11. The method of claim 1, wherein the catalytic solvent comprises an aryl solvent substituted with one or more nitrile groups, an alkyl solvent substituted with one or more nitrile groups, or a combination thereof.

12. The method of claim 11, wherein the aryl solvent substituted with one or more nitrile groups and the secondary sulfide are present in a mol ratio from about 0.5:1 to about 1.5:1.

13. The method of claim 11, wherein a combination of the aryl solvent substituted with one or more nitrile groups and the alkyl solvent substituted with one or more nitrile groups and the secondary sulfide are present in a mol ratio from about 0.5:1 to about 1.5:1.

14. The method of claim 11, wherein the alkyl solvent substituted with one or more nitrile groups and the aryl solvent substituted with one or more nitrile groups are present in a mol ratio from about 6:1 to about 12:1.

15. The method of claim 1, wherein the spectator solvent comprises a hydrocarbon-based solvent.

16. The method of claim 15, wherein the spectator solvent comprises an alkane or blend of alkanes, xylene, toluene, benzene, decalin, 1,2,3,4-tetrahydronaphthalene, or combinations thereof.

17. The method of claim 1, further comprising heating the sulfide-based solid electrolyte to a temperature from about 350° C. to about 550° C.

18. The method of claim 1, further comprising milling the mixture or drying the sulfide-based solid electrolyte under vacuum or atmospheric pressure.

19. The method of claim 1, further comprising producing a thiophosphate intermediate.

20. The method of claim 19, wherein the thiophosphate intermediate comprises P₂S₆⁴⁻ and/or PS(₄₋ₓ)Oₓ, wherein x is between 0 and 4.

21. The method of claim 1, wherein the sulfide-based solid electrolyte comprises Li₃PS₄.

22. The method of claim 21, wherein the sulfide-based solid electrolyte comprises fewer impurities as compared to a sulfide-based solid electrolyte prepared with a non-coordinating non-reactive solvent.

23. The method of claim 21, wherein the sulfide-based solid electrolyte has at least a 25% greater ionic conductivity as compared to a sulfide-based solid electrolyte prepared with a non-coordinating non-reactive solvent.

24. A method for producing a sulfide-based solid electrolyte with an Argyrodite phase comprising:
mixing sulfide-based solid electrolyte precursors comprising Li₂S, P₂S₅, and LiX in a blend of solvents comprising a catalytic solvent and a spectator solvent to produce a sulfide-based solid electrolyte,
wherein X═F, Cl, Br, or I; and
crystallizing the sulfide-based solid electrolyte,
wherein the required mixing time of the sulfide-based solid electrolyte precursors is half (50%) or less in the presence of the catalytic solvent compared to using a spectator solvent only.

25. A composition comprising a Li₃PS₄ and a thiophosphate comprising one or more of PS₄ and P₂S₇ and P₂S₆ and an Argyrodite phase, wherein the composition comprises from 0.01 to 0.90 wt % of a nitrile selected from the group consisting of acetonitrile, propionitrile, butyronitrile, isobutyronitrile, benzonitrile, and combinations thereof.
